(19) United States
(12) Patent Application Publication
(10) Pub. No.: US 2014/0055427 A1
(43) Pub. Date: Feb. 27, 2014

(54) MOBILE TERMINAL AND CONTROL METHOD THEREOF

(71) Applicants: Yung KIM, Seoul (KR); Seoyeon Lee, Seoul (KR); Suyoung Lee, Seoul (KR)

(72) Inventors: Yung KIM, Seoul (KR); Seoyeon Lee, Seoul (KR); Suyoung Lee, Seoul (KR)

(21) Appl. No.: 13/961,212

(22) Filed: Aug. 7, 2013

(30) Foreign Application Priority Data
Aug. 23, 2012 (KR) 10-2012-0092116

(51) Int. Cl. G06F 3/0354

(52) U.S. Cl. CPC G06F 3/03545
USPC 345/179

(57) ABSTRACT

A mobile terminal and a control method thereof are disclosed. The mobile terminal includes a display and a controller configured to execute a function corresponding to a user gesture acquired through a stylus when at least one of the body and tip of the stylus does not come into contact with the display. The mobile terminal can be controlled more intuitively by executing a function corresponding to a user gesture acquired through the stylus.

### CROSS-REFERENCE TO RELATED APPLICATIONS

Pursuant to 35 U.S.C. §119(a), this application claims the benefit of earlier filing date and right of priority to Korean Patent Application No. 10-2012-0092116, filed on 23 Aug., 2012, the contents of which are incorporated by reference herein in their entirety.

### TECHNICAL FIELD

The present invention relates to a mobile terminal and, more particularly, to a mobile terminal and a control method thereof to control the mobile terminal in a more intuitive manner by executing a function corresponding to a user gesture acquired through a stylus.

### DISCUSSION OF THE RELATED ART

As functions of terminals such as personal computers, laptop computers, cellular phones diversify, the terminals become multimedia players having multiple functions for capturing pictures or moving images, playing music, moving image files and games and receiving broadcasting programs.

Terminals can be categorized as mobile terminals and stationary terminals. The mobile terminals can be further comprised of handheld terminals and vehicle mount terminals according to whether users can personally carry the terminals. Conventional terminals including mobile terminals provide an increasing number of complex and various functions.

To support and enhance the increasing number of functions in a terminal, improving a structural part and/or a software part of the terminal would be desirable.

The terminal may include a stylus. A user can perform a more accurate touch operation using the stylus.

The above references are incorporated by reference herein where appropriate for appropriate teachings of additional or alternative details, features and/or technical background.

### SUMMARY

The present invention relates to a mobile terminal and a control method thereof to control the mobile terminal in a more intuitive manner by executing a function corresponding to a user gesture acquired through a stylus.

### BRIEF DESCRIPTION OF THE DRAWINGS

The embodiments will be described in detail with reference to the following drawings in which like reference numerals refer to like elements wherein:

The accompanying drawings, which are included to provide a further understanding of the invention and are incorporated in and constitute a part of this application, illustrate embodiment(s) of the invention and together with the description serve to explain the principle of the invention.

FIG. 1 is a block diagram of a mobile terminal according to an embodiment;

FIG. 2A is a front perspective view of the mobile terminal according to an embodiment;

FIG. 2B is a rear perspective view of the mobile terminal according to an embodiment;

FIG. 3 is a view for explaining a proximity depth of a proximity sensor;

FIG. 4 shows exemplary mobile terminals according to embodiments of the present invention;

FIG. 5 shows engagement of a stylus with a mobile terminal according to an embodiment of the present invention;

FIG. 6 shows the stylus of FIG. 5;

FIG. 7 is a block diagram of the stylus shown in FIG. 6;

FIG. 8 is a flowchart illustrating operations of a mobile terminal according to an embodiment of the present invention;

FIG. 9 illustrates a general operation of using the stylus shown in FIG. 6;

FIGS. 10 to 14 illustrate various user gestures using the stylus shown in FIG. 6;

FIGS. 15 to 21 illustrate operations of the mobile terminal of FIG. 1 according to positions of the stylus of the mobile terminal;

FIGS. 22 to 26 illustrate an unlock function of the mobile terminal of FIG. 1 according to a user gesture using the stylus;

FIGS. 27 to 29 illustrate a delete function of the mobile terminal of FIG. 1 according to a user gesture using the stylus;

FIGS. 30 to 34 illustrate a memo function of the mobile terminal of FIG. 1 according to a user gesture using the stylus;

FIGS. 35 to 39 illustrate a scroll function of the mobile terminal of FIG. 1 according to a user gesture using the stylus;

FIG. 40 illustrates selection of a function of the mobile terminal of FIG. 1 according to operation of pushing the stylus;

FIG. 41 illustrates a function corresponding to an operation of rubbing the stylus of the mobile terminal of FIG. 1;

FIGS. 42 to 44 illustrate an operation of the mobile terminal of FIG. 1 according to a distance between the stylus and a display of the mobile terminal;

FIGS. 45 and 46 illustrate an operation of the mobile terminal of FIG. 1 according to location of the stylus;

FIGS. 47 to 50 illustrate a function corresponding to an operation of shaking the stylus of the mobile terminal of FIG. 1;

FIGS. 51 and 52 illustrate a stylus function when the mobile terminal of FIG. 1 receives a call;

FIG. 53 illustrates a function of correcting a font using the stylus of the mobile terminal of FIG. 1;

FIGS. 54 to 56 illustrate a function relating to the stylus of the mobile terminal of FIG. 1;

FIGS. 57 to 59 illustrate another function relating to the stylus of the mobile terminal of FIG. 1; and

FIGS. 60 to 62 illustrate the relationship between the mobile terminal of FIG. 1 and a specific stylus.

### DETAILED DESCRIPTION

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

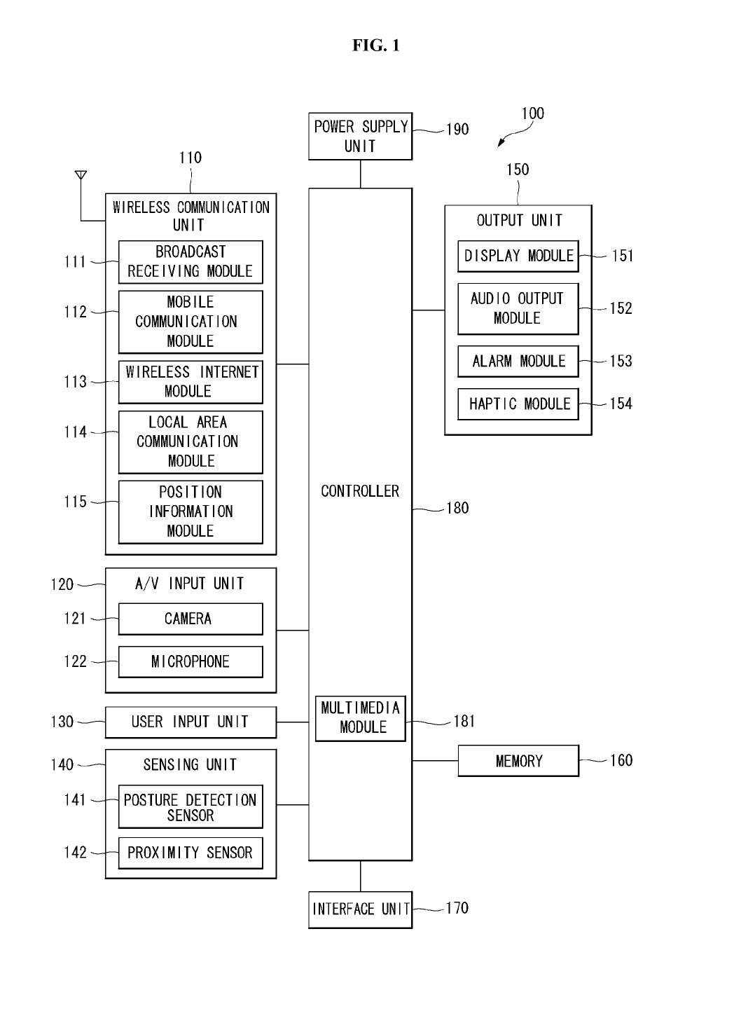

FIG. 1 is a block diagram of a mobile terminal according to an embodiment. Other embodiments, configurations and arrangements may also be provided.

As shown, the mobile terminal 100 may include a wireless communication unit 110 (or radio communication unit), an audio/video (A/V) input unit 120, a user input unit 130, a sensing unit 140, an output unit 150, a memory 160, an interface 170, a controller 180, and a power supply 190. The components shown in FIG. 1 may be essential parts and/or a number of components included in the mobile terminal 100 may vary. Components of the mobile terminal 100 may now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114 (or local area communication module), and a location information module 115 (or position information module).

The broadcasting receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 may correspond to a module for short range communication. Further, Bluetooth®, radio frequency identification (RFID), infrared data association (IrDA), ultra wideband (UWB) and/or ZigBee® may be used as a short range communication technique.

The location information module 115 may confirm or obtain a location or a position of the mobile terminal 100. The location information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 115. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module may continuously calculate a current position in real time and calculate velocity information using the location or position information.

The A/V input unit 120 may input (or receive) an audio signal and/or a video signal. The A/V input unit 120 may include a camera 121 and a microphone 122. The camera 121 may process image frames of still images or moving images obtained by an image sensor in a video telephony mode or a photographing mode. The processed image frames may be displayed on a display 151, which may be a touch screen.

The image frames processed by the camera 121 may be stored in the memory 160 or may be transmitted to an external device through the wireless communication unit 110. The mobile terminal 100 may also include at least two cameras 121.

The microphone 122 may receive an external audio signal in a call mode, a recording mode and/or a speech recognition mode, and the microphone 122 may process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 may generate a sensing signal for controlling operation of the mobile terminal 100. For example, in an example of a slide phone, the sensing unit 140 may sense whether the slide phone is opened or closed. Further, the sensing unit 140 may sense whether the power supply 190 supplies power and/or whether the interface 170 is connected to an external device. The sensing unit 140 may also include a proximity sensor 141. The sensing unit 140 may sense a motion of the mobile terminal 100.

The output unit 150 may generate visual, auditory and/or tactile output, and the output unit 150 may include the display 151, an audio output module 152, an alarm 153 and a haptic module 154. The display 151 may display information processed by the mobile terminal 100. The display 151 may display a user interface (UI) and/or a graphic user interface (GUI) related to a telephone call when the mobile terminal 100 is in the call mode. The display 151 may also display a captured and/or received image, a UI or a GUI when the mobile terminal 100 is in the video telephony mode or the photographing mode.

The display 151 may include at least one of a liquid crystal display, a thin film transistor liquid crystal display, an organic light-emitting diode display, a flexible display and/or a three-dimensional display. The display 151 may be of a transparent type or a light transmissive type. That is, the display 151 may include a transparent display.

The transparent display may be a transparent liquid crystal display. A rear structure of the display 151 may also be of a light transmissive type. Accordingly, a user may see an object located behind the body (of the mobile terminal 100) through the transparent area of the body of the mobile terminal 100 that is occupied by the display 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and/or a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display 151.

The proximity sensor 141 (of the sensing unit 140) may be located in an internal region of the mobile terminal 100, surrounded by the touch screen, and/or near the touch screen. The proximity sensor 141 may sense an object approaching a predetermined sensing face or an object located near the proximity sensor 141 using an electromagnetic force or infrared rays without having mechanical contact. The proximity sensor 141 may have a lifetime longer than a contact sensor and may thus have a wide application in the mobile terminal 100.

The proximity sensor 141 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor 141.

For ease of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor 141 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen.

The audio output module 152 may output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm 153 may output a signal for indicating generation of an event of the mobile terminal 100. For example, an alarm may be generated when receiving a call signal, receiving a message, inputting a key signal, and/or inputting a touch. The alarm 153 may also output signals in forms different from video signals or audio signals, for example, a signal for indicating generation of an event through vibration. The video signals and/or the audio signals may also be output through the display 151 or the audio output module 152.

The haptic module 154 may generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operations of the controller 180 and/or temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 may control overall operations of the mobile terminal 100. For example, the controller 180 may perform control and processing for voice communication, data communication and/or video telephony. The controller 180 may also include a multimedia module 181 for playing multimedia. The multimedia module 181 may be included in the controller 180 or may be separated from the controller 180.

The controller 180 may perform a pattern recognition process capable of recognizing handwriting input or picture-drawing input applied to the touch screen as characters or images. The power supply 190 may receive external power and internal power and provide power required for operations of the components of the mobile terminal 100 under control of the controller 180.

According to hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to software implementation, embodiments such as procedures or functions may be implemented with a separate software module that executes at least one function or operation. Software codes may be implemented according to a software application written in an appropriate software language. The software codes may be stored in the memory 160 and executed by the controller 180.

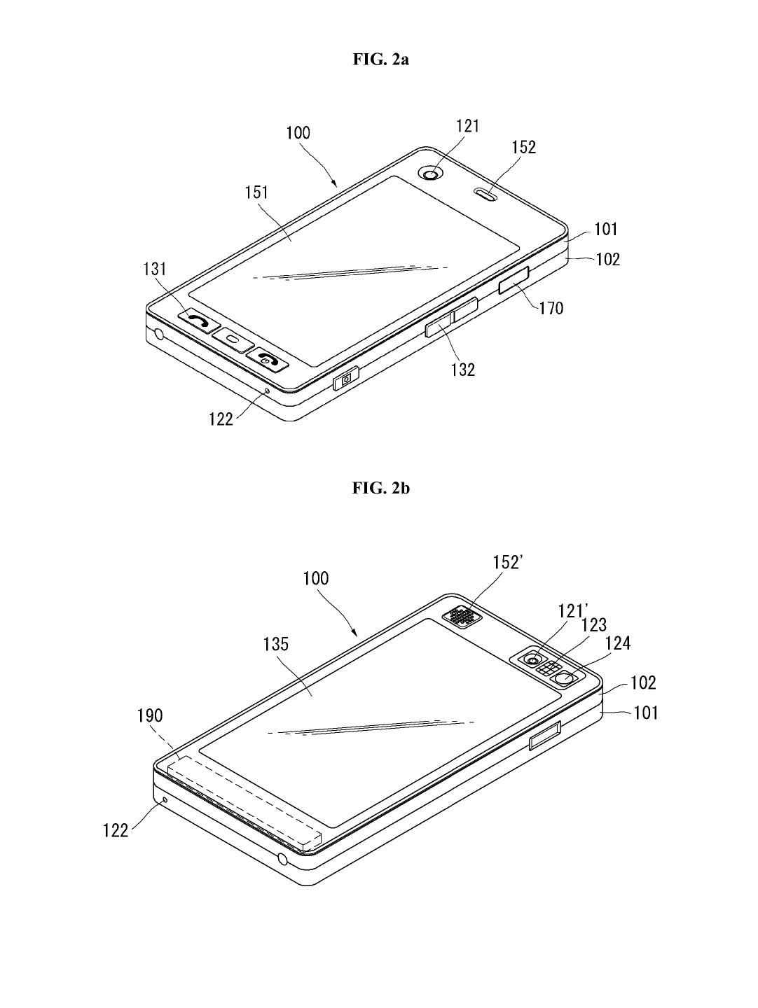

FIG. 2A is a front perspective view of a mobile terminal (or a handheld terminal) according to an embodiment.

The mobile terminal 100 may be a bar type terminal body. However, embodiments are not limited to a bar type terminal and may be applied to terminals of various types including slide type, folder type, swing type and/or swivel type terminals having at least two bodies that are relatively movably combined.

The terminal body may include a case (a casing, a housing, a cover, etc.) that forms an exterior of the mobile terminal 100. In this embodiment, the case may be divided into a front case 101 and a rear case 102. Various electronic components may be arranged in the space formed between the front case 101 and the rear case 102. At least one middle case may be additionally provided between the front case 101 and the rear case 102.

The cases may be formed of plastics through injection molding or made of a metal material such as stainless steel (STS) or titanium (Ti).

The display 151, the audio output unit 152, the camera 121, the user input unit 130/131 and 132, the microphone 122 and the interface 170 may be arranged (or provided) in the terminal body, and more specifically may be arranged (or provided) in the front case 101.

The display 151 may occupy most of the main face of the front case 101. The audio output unit 152 and the camera 121 may be arranged in a region in proximity to one of both ends of the display 151 and the user input unit 131, and the microphone 122 may be located in a region in proximity to another end of the display 151. The user input unit 132 and the interface 170 may be arranged (or provided) on sides of the front case 101 and the rear case 102.

The user input unit 130 may receive commands for controlling operation of the mobile terminal 100, and may include a plurality of operating units 131 and 132. The operating units 131 and 132 may be referred to as manipulating portions and may employ any tactile manner in which a user operates the operating units 131 and 132 while having tactile feeling.

The first and second operating units 131 and 132 may receive various inputs. For example, the first operating unit 131 may receive commands such as start, end and scroll and the second operating unit 132 may receive commands such as control of a volume of sound output from the audio output unit 152 or conversion of the display 151 to a touch recognition mode.

FIG. 2B is a rear perspective view of the mobile terminal (shown in FIG. 2A) according to an embodiment.

Referring to FIG. 2A, a camera 121′ may be additionally attached to the rear side of the terminal body (i.e., the rear case 102). The camera 121′ may have a photographing direction opposite to that of the camera 121 (shown in FIG. 2A) and may have pixels different from those of the camera 121 (shown in FIG. 2A).

For example, it may be desirable that the camera 121 has low pixels such that the camera 121 may capture an image of a face of a user and transmit the image to a receiving part in case of video telephony while the camera 121′ has high pixels because the camera 121′ captures an image of a general object and does not immediately transmit the image in many cases. The cameras 121 and 121′ may be attached (or provided) to the terminal body such that the cameras 121 and 121′ may rotate or pop-up.

A flash bulb 123 and a mirror 124 may be additionally provided in proximity to the camera 121′. The flash bulb 123 may light an object when the camera 121′ takes a picture of the object. The mirror 124 may be used for the user to look at his/her face in the mirror when the user wants to self-photograph himself/herself using the camera 121′.

An audio output unit 152′ may be additionally provided on the rear side of the terminal body. The audio output unit 152′ may achieve a stereo function with the audio output unit 152 (shown in FIG. 2A) and may be used for a speaker phone mode when the terminal is used for a telephone call.

A broadcasting signal receiving antenna may be additionally attached (or provided) to the side of the terminal body in addition to an antenna for telephone calls. The antenna constructing a part of the broadcasting receiving module 111 (shown in FIG. 1) may be set in the terminal body such that the antenna may be pulled out of the terminal body.

The power supply 190 for providing power to the mobile terminal 100 may be set in the terminal body. The power supply 190 may be included in the terminal body or may be detachably attached to the terminal body.

A touch pad 135 for sensing touch may be attached to the rear case 102. The touch pad 135 may be of a light transmission type, such as the display 151. In this example, if the display 151 outputs visual information through both sides thereof, the visual information may be recognized (or determined) by the touch pad 135. The information output through both sides of the display 151 may be controlled by the touch pad 135. Otherwise, a display may be additionally attached (or provided) to the touch pad 135 such that a touch screen may be arranged (or provided) even in the rear case 102.

The touch pad 135 may operate in connection with the display 151 of the front case 101. The touch pad 135 may be located in parallel with the display 151 behind the display 151. The touch panel 135 may be identical to or smaller than the display 151 in size.

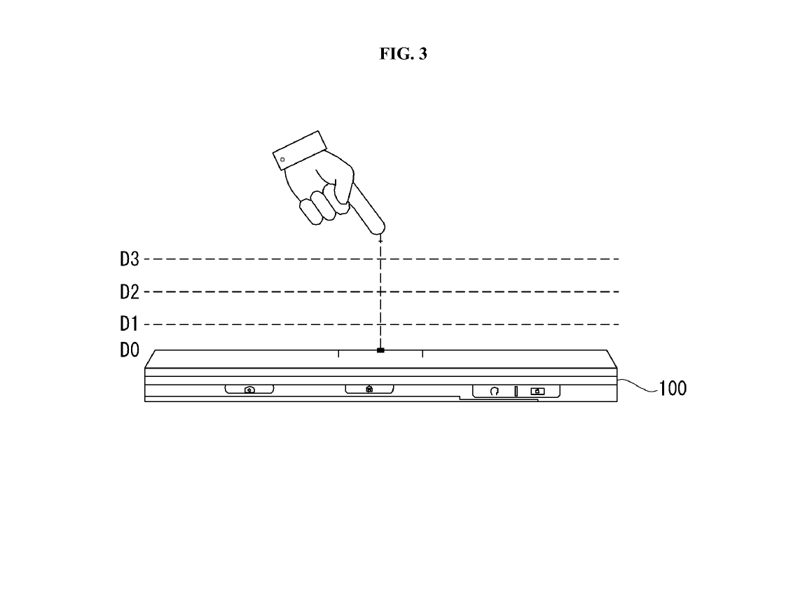

FIG. 3 is a view for explaining a proximity depth of a proximity sensor.

As shown in FIG. 3, when a pointer (such as a user's finger) approaches the touch screen, the proximity sensor located inside or near the touch screen may sense the approach of the pointer, and may output a proximity signal.

The proximity sensor may be constructed such that the proximity sensor outputs a proximity signal according to a distance between the pointer approaching the touch screen and the touch screen (referred to as “proximity depth”).

The distance in which the proximity signal is output when the pointer approaches the touch screen may be referred to as a detection distance. The proximity depth may be determined by using a plurality of proximity sensors having different detection distances and by comparing proximity signals respectively output from the proximity sensors.

FIG. 3 shows a section of the touch screen in which proximity sensors capable of sensing three proximity depths may be provided. Proximity sensors capable of sensing less than three or more than four proximity depths may be provided in the touch screen.

More specifically, when the pointer completely contacts the touch screen (D0), it may be recognized as contact touch. When the pointer is located within a distance D1 from the touch screen, it may be recognized as a proximity touch of a first proximity depth. When the pointer is located in a range between the distance D1 and a distance D2 from the touch screen, it may be recognized as a proximity touch of a second proximity depth. When the pointer is located in a range between the distance D2 and a distance D3 from the touch screen, it may be recognized as a proximity touch of a third proximity depth. When the pointer is located greater than the distance D3 from the touch screen, it may be recognized as cancellation of the proximity touch.

Accordingly, the controller 180 may recognize the proximity touch as various input signals according to proximity distance and proximity position of the pointer with respect to the touch screen, and the controller 810 may perform various operation controls according to the input signals.

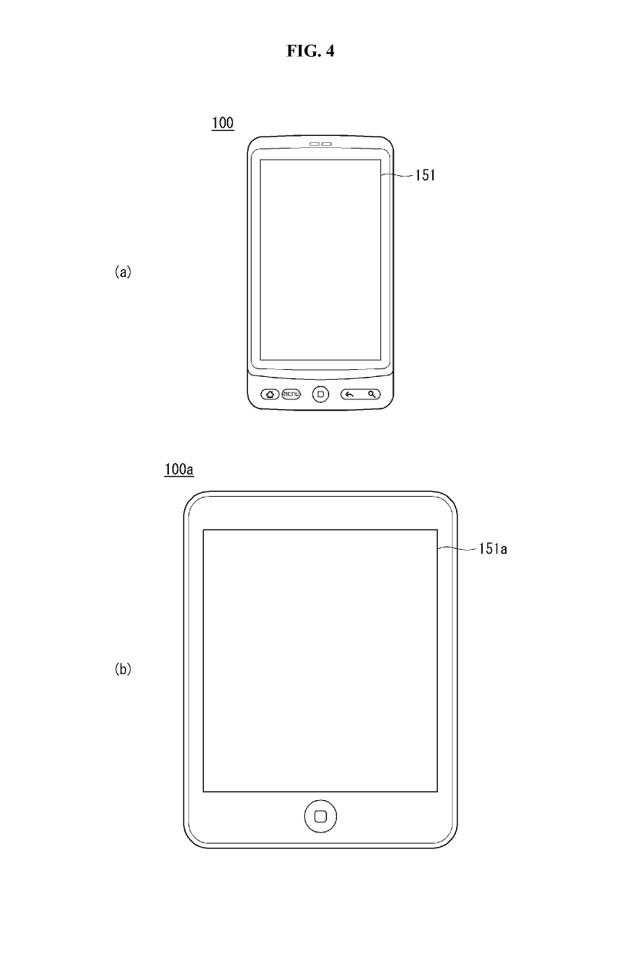

FIG. 4 shows exemplary mobile terminals according to embodiments of the present invention;

As shown in FIG. 4, the present invention can be applied to mobile terminals 100 and 100a having various forms.

Referring to FIG. 4(a), the mobile terminal 100 may include the display 151 having a conventional form. For example, the present invention can be applied to the mobile terminal 100 in a size such that the user can touch the display 151 with a hand gripping the mobile terminal 100.

Referring to FIG. 4(b), the mobile terminal 100a may include a large display 151a. For example, the present invention can be applied to the mobile terminal 100a in a size such that the user cannot touch the display 151a with a hand gripping the mobile terminal 100a.

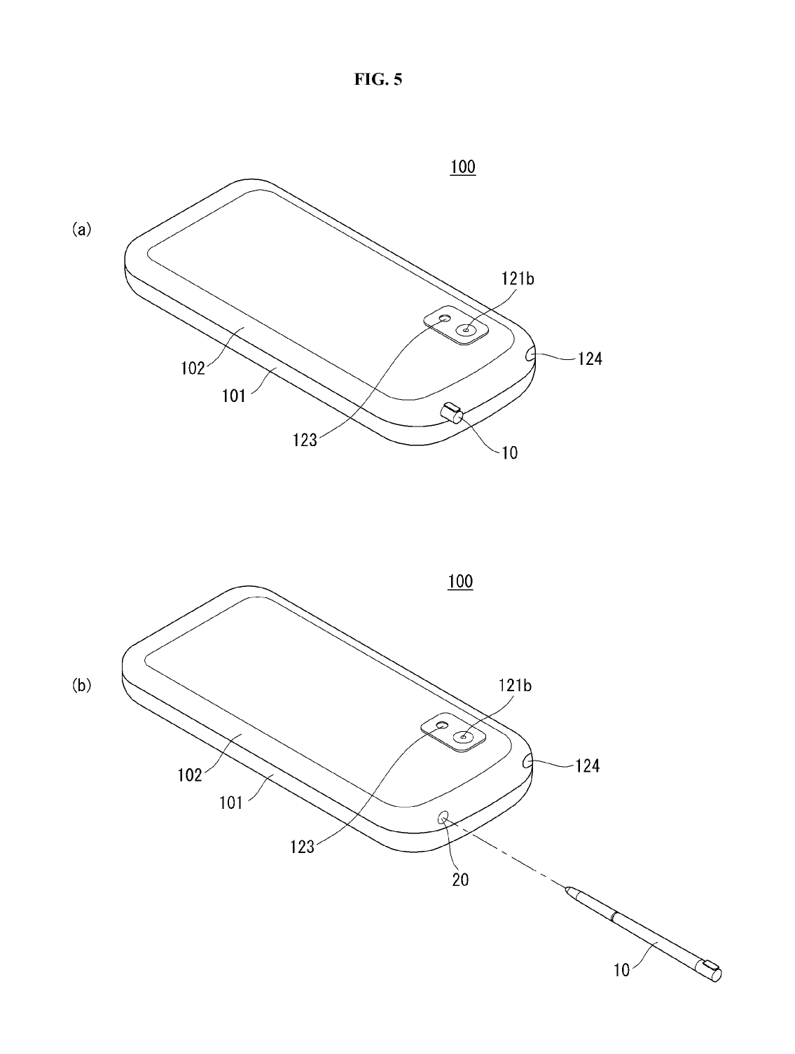

FIG. 5 shows engagement of a stylus with a mobile terminal according to an embodiment of the present invention.

As shown in FIG. 5, a stylus 10 can be fitted in the body of the mobile terminal 100.

Referring to FIG. 5(a), the stylus 10 may be inserted into one side of the body of the mobile terminal 100.

Referring to FIG. 5(b), the stylus 10 may be ejected from the body of the mobile terminal 100 by a user. Specifically, the stylus 10 inserted into a stylus combining hole 20 formed at the body of the mobile terminal 100 can be separated from the stylus combining hole 20. The stylus 10 ejected from the mobile terminal 100 can be used separately from the mobile terminal 100.

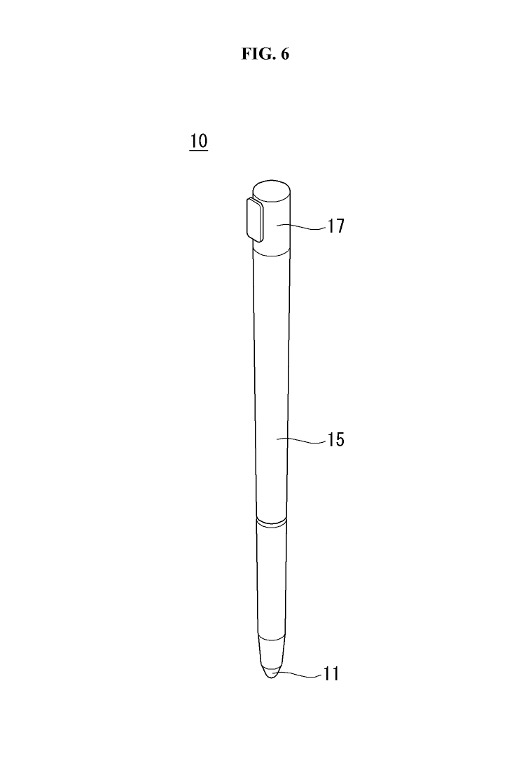

FIG. 6 shows the stylus of FIG. 5.

Referring to FIG. 6, the stylus 10 of the mobile terminal 100 according to an embodiment of the present invention may include a body 15, a tip 11 corresponding to one end of the body 15, and a rear portion 17 corresponding to the other end of the body 15.

The body 15 may be a portion gripped by the user. That is, the user can grip the body 15 with fingers to manipulate the stylus 10 in an environment in which the stylus is normally used. The body 15 may be made of plastics, metal, etc.

The tip 11 may be a portion that comes into contact with the display 151. That is, the user who grips the body 15 can use the stylus 10 with the tip 11 facing downward in an environment in which the stylus 10 is normally used. The tip 11 that comes into contact with the display 151 may be made of a soft material such as plastics, rubber, etc.

The rear portion 17 may correspond to the top end of the stylus 10. The stylus 10 can be combined with the body of the mobile terminal 100 through the rear portion 17. For example, when the stylus 10 is inserted into the stylus combining hole 20, the stylus 10 can be engaged with the body of the mobile terminal 100.

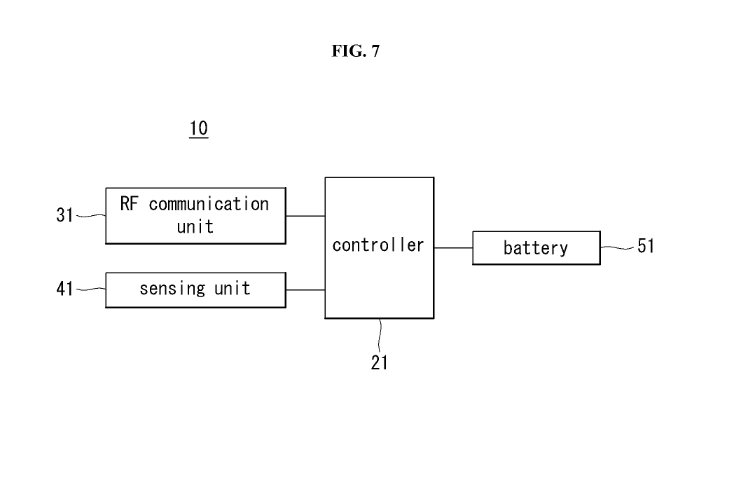

FIG. 7 is a block diagram of the stylus of FIG. 6.

As shown in FIG. 7, the stylus 10 according to an embodiment of the present invention may include a controller 21, an RF communication unit 31, a sensing unit 41 and a battery 51.

The controller 21 may generate a control signal for controlling components of the stylus 10. That is, the controller 21 can control the components of the stylus 10, which will be described below.

The stylus 10 can communicate with an external device through the RF communication unit 31. For example, the RF communication unit 31 can be a short-range communication means including Bluetooth, which communicates with the mobile terminal 100.

The sensing unit 41 can sense a user gesture of manipulating the stylus 10. The sensing unit 41 may include a posture sensor such as an acceleration sensor, a geomagnetic sensor, etc., a contact sensor sensing contact of a user's hand with a specific point of the stylus 10, and a button type sensor positioned at a specific point of the body 15 of the stylus 10. The sensing unit 41 can sense a user gesture of gripping the stylus 10, facing the stylus 10 to a specific direction or shaking the stylus 10.

The battery 51 can supply power to the components of the stylus 10 including the controller 21. The battery 51 may be charged when the stylus 10 is fitted in the stylus combining hole 20. Otherwise, the battery 51 may be charged in a wireless manner. That is, the battery 51 of the stylus 10 can be charged wirelessly even when the mobile terminal 100 and the stylus 10 do not have terminals corresponding to each other.

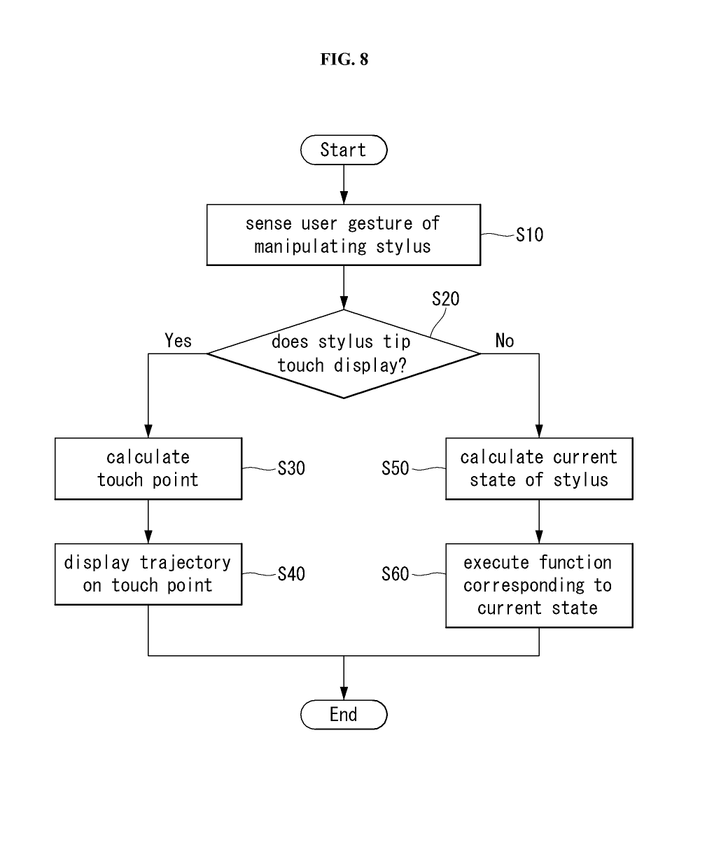

FIG. 8 is a flowchart illustrating operations of the mobile terminal according to an embodiment of the present invention.

As shown in FIG. 8, the controller 180 of the mobile terminal 100 according to an embodiment of the present invention can execute a function corresponding to a user gesture of manipulating the stylus 10.

A user gesture of manipulating the stylus 10 may be sensed (S10).

The stylus 10 may sense a user gesture through the sensing unit 41. For example, the stylus 10 can sense whether the user puts the stylus 10 down, holds the stylus 10 in order to use the stylus 10, or properly grips the stylus 10.

It can be determined whether the tip 11 of the stylus 10 comes into contact with the display 151 (S20).

A general operation using the stylus 10 is performed when the tip 11 of the stylus 10 comes into contact with the display 151. For example, when the tip 11 comes into contact with the display 151, the controller 180 of the mobile terminal 100 can sense the contact and perform an operation corresponding to the sensed result.

Upon contact of the tip 11 with the display 151, a contact point may be calculated (S30) and a trajectory may be indicated on the contact point (S40).

The contact point may be a point on the plane of the display 151.

When the tip 11 of the stylus 10 comes into contact with the point on the plane of the display 151, the controller 180 can display a trajectory corresponding to the contact on the display 151. For example, the controller 180 can display a trajectory of the moving tip 11 as a solid line.

When the tip 11 does not come into contact with the display 151, a current state of the stylus 10 may be calculated (S50).

The current state of the stylus 10 may be acquired through the sensing unit 41. For example, the sensing unit 41 can sense whether the stylus 10 is held by the user and how the stylus 10 is held by the user.

A function corresponding to the current state of the stylus 10 may be executed (S60).

The controller 180 may execute a function corresponding to the gripped state of the stylus 10. That is, the controller 180 can execute a function corresponding to a gesture of manipulating the stylus 10.

The controller 10 can determine an intention of the user who grips the stylus 10 from the user gesture of manipulating the stylus 10. For example, when the user makes a gesture of writing a letter using the stylus 10 without the stylus 10 coming into contact with the display 151, the controller 180 can determine that the user attempts to make a rough sketch. If the user spins the stylus 10, the controller 180 can determine that the user attempts to change a displayed screen. That is, the user can control the mobile terminal 100 using the stylus 10 more conveniently. Accordingly, the function of the stylus 10, which senses an accurate touch operation applied to the display 151, can be extended.

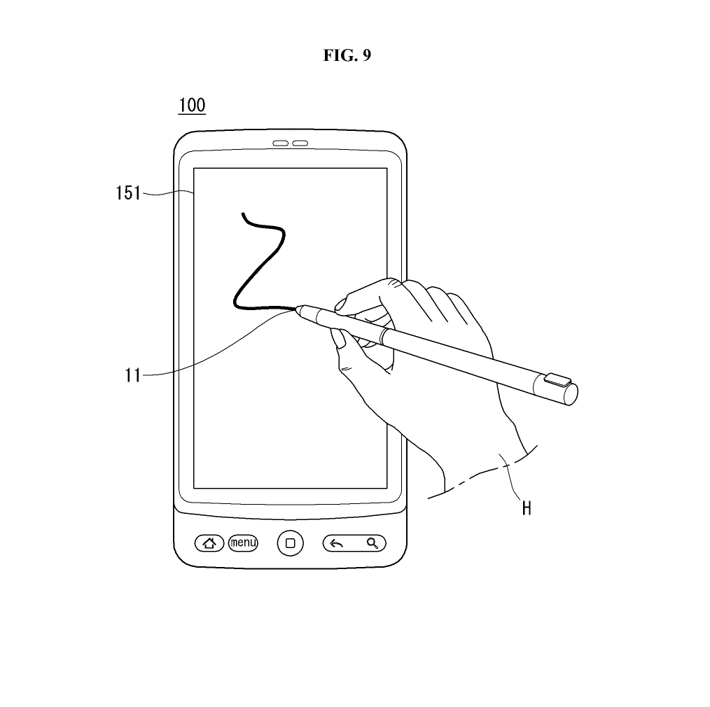

FIG. 9 shows an operation of normally using the stylus of FIG. 6.

As shown in FIG. 9, the user may apply an input to the mobile terminal 100 using the stylus 10 by touching the display 151 of the mobile terminal 100 with the stylus 10. That is, when the user presses a specific point of the display 151 with the tip 11 of the stylus 10, a touch sensor of the display 151 can sense the specific point. It is possible to apply a more accurate input by using the tip 11 of the stylus 10, which is narrower than a user's finger.

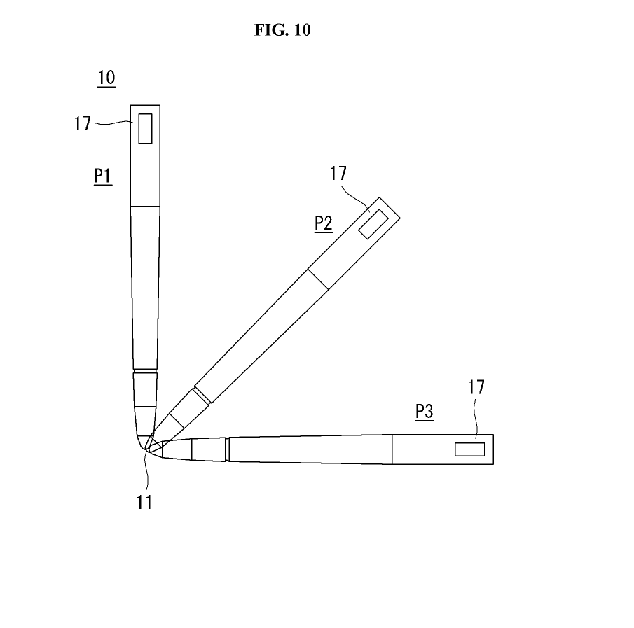

FIGS. 10 to 14 illustrate various gestures of manipulating the stylus of FIG. 6.

As shown in FIGS. 10 to 14, the stylus 10 according to an embodiment of the present invention can sense various user gestures of manipulating the stylus 10. A user gesture of manipulating the stylus 10 may reflect an intention of the user. According to an embodiment of the present invention, a specific function of the mobile terminal 100 can be executed on the basis of a user gesture of manipulating the stylus 10, and thus the mobile terminal 100 can be used more conveniently.

Referring to FIG. 10, the stylus 10 according to an embodiment of the present invention may be located in a first position P1, a second position P2 or a third position P3. In the first position P1, the stylus 10 may be positioned in perpendicular to the ground or the display 151 of the mobile terminal 100. In the second position P2, the stylus 10 may be located at a predetermined angle to the ground or the display 151 of the mobile terminal 100. In the third position P3, the stylus 10 is located in parallel with the ground or the display 151 of the mobile terminal 100.

The controller 21 can determine the position of the stylus 10 on the basis of a sensed result of the sensing unit 41. Furthermore, the controller 21 can speculate an intention of the user according to the position of the stylus 10. For example, if the stylus 10 is located in the second position P2, the controller 21 can assume that the user attempts to apply an input using the stylus 10. If the stylus 10 is located in the third position P3, the controller 21 can assume that the user attempts to stop inputting using the stylus 10.

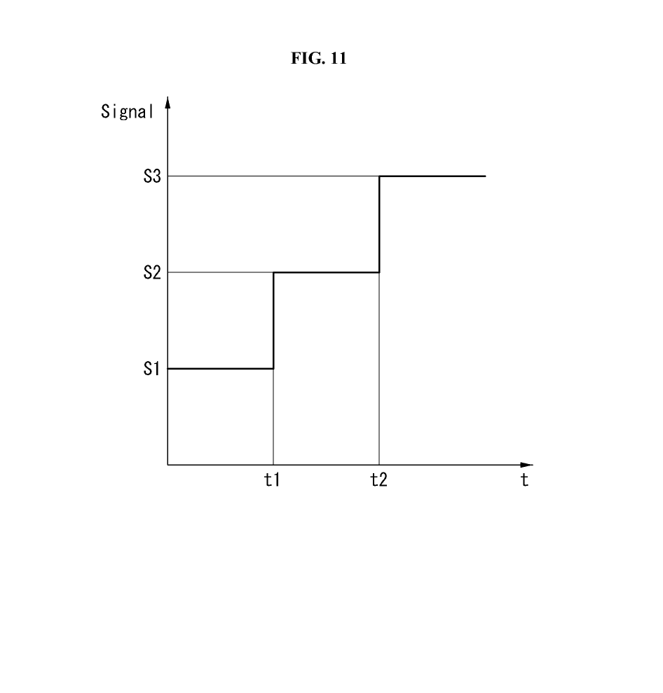

Referring to FIG. 11, when the stylus 10 is located in the first, second and third positions P1, P2 and P3, the controller 21 can generate different control signals. For example, the controller 21 can generate first, second and third control signals S1, S2 and S3 when the stylus 10 is located in the first, second and third positions P1, P2 and P3, respectively. The first, second and third control signals S1, S2 and S3 generated by the controller 21 of the stylus 10 can be transmitted to the mobile terminal 100 through the RF communication unit 31, and the controller 180 of the mobile terminal 100 can determine user gestures of manipulating the stylus 10 on the basis of the control signals transmitted from the stylus 10.

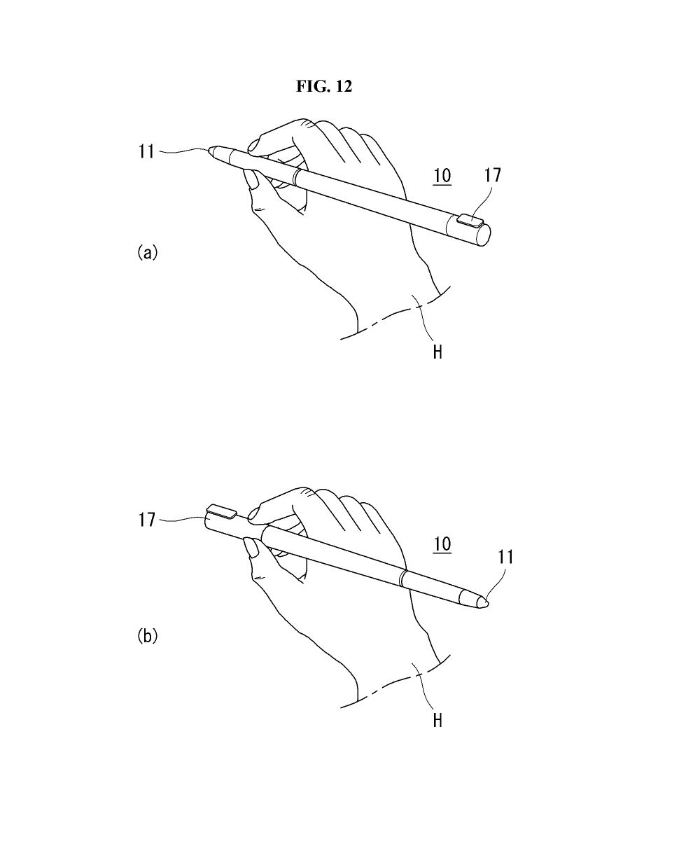

FIGS. 12, 13 and 14 illustrate various gestures of manipulating the stylus 10

Referring to FIG. 12(a), the user may grip the stylus 10 with a hand H with the tip 11 of the stylus 11 facing down.

Referring to FIG. 12(b), the user may grip the stylus 10 with the hand H with the tip 11 of the stylus 11 facing up. That is, the user can grip the stylus 10 using the hand H with the rear portion 17 of the stylus 10 facing down.

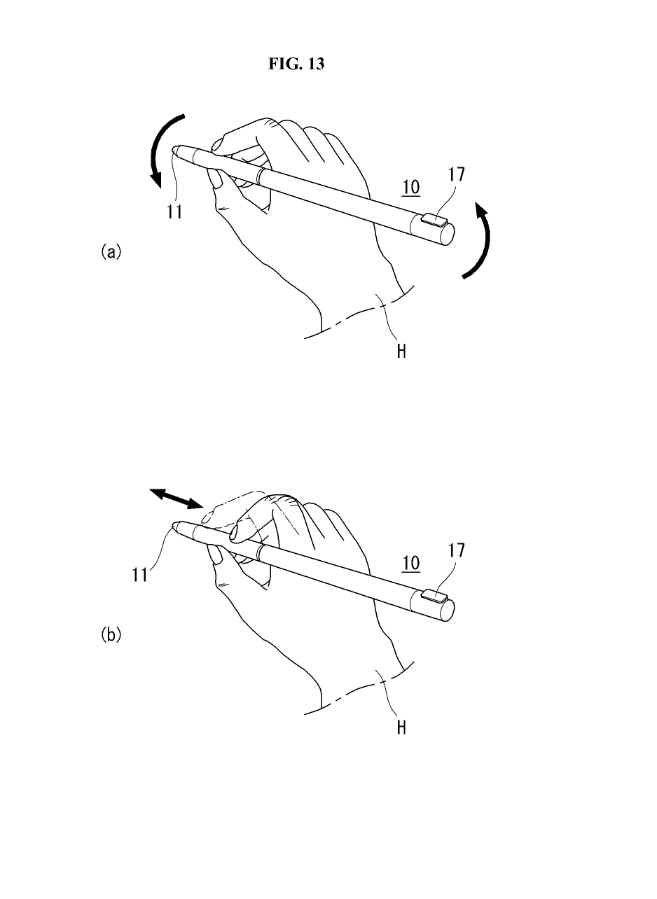

Referring to FIG. 13(a), the user may spin the stylus 10. For example, the user can spin the stylus 10 as if the user spins a pen.

Referring to FIG. 13(b), the user may make a gesture of rubbing the body 15 of the stylus 10. That is, the user can make a gesture of moving a finger F in the longitudinal direction of the body 15 of the stylus 10 such that a contact point is continuously changed.

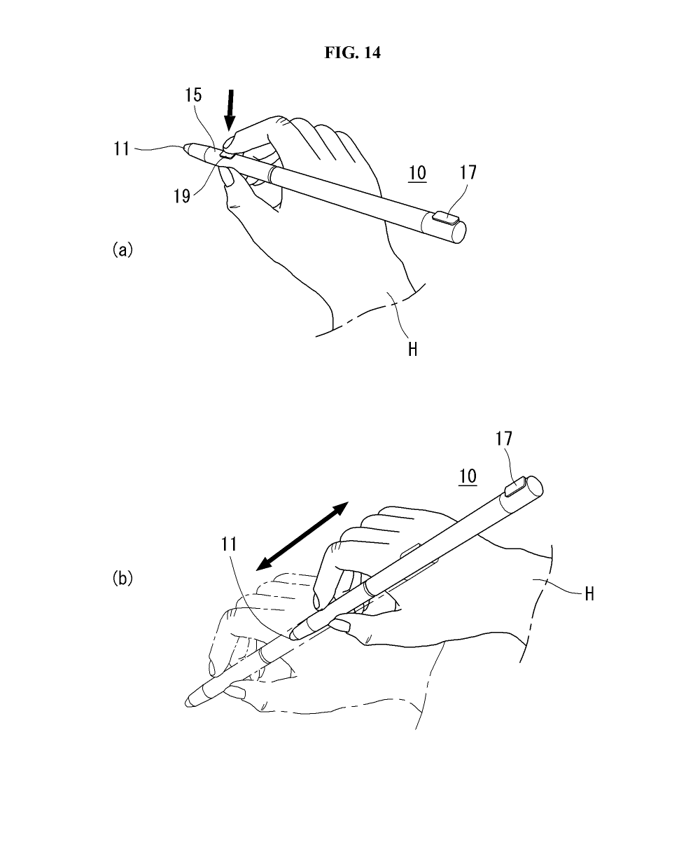

Referring to FIG. 14(a), the stylus 10 may include a button 19. The user may push the button 19 provided to the stylus 10.

Referring to FIG. 14(b), the user may shake the stylus 10. For example, the user can shake the stylus 10 back and forth using a wrist snap.

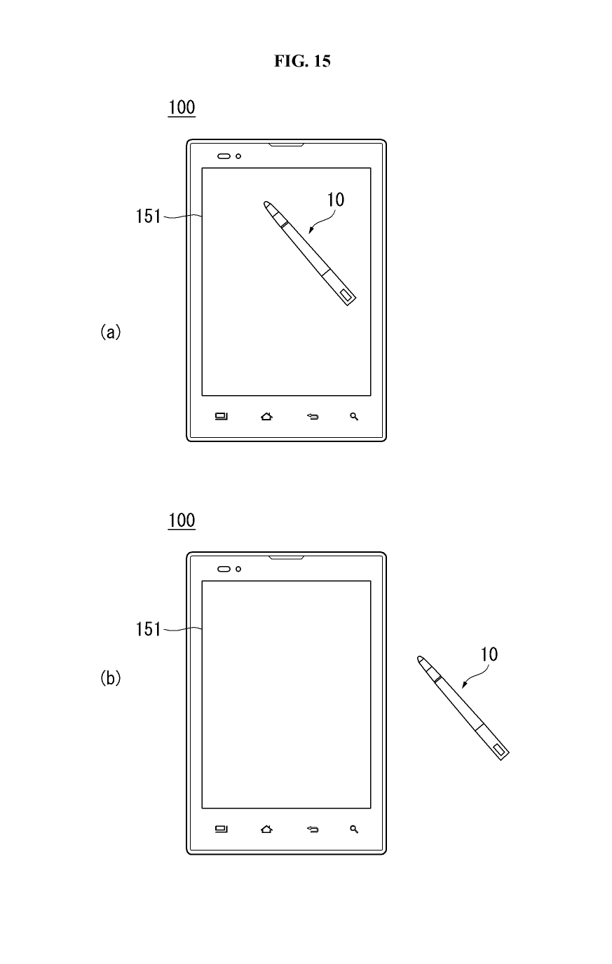

FIGS. 15 to 21 illustrate operations according to positions of the mobile terminal of FIG. 1 and the stylus.

As shown in FIGS. 15 to 21, the mobile terminal 100 according to an embodiment of the present invention may perform a specific operation on the basis of a user gesture of manipulating the stylus 10

Referring to FIG. 15, the user may place the stylus 10 in different positions according to circumstances. For example, the user can place the stylus 10 on the display 151 of the mobile terminal 100, as shown in FIG. 15(a), or place the stylus 10 by the mobile terminal 100, as shown in FIG. 15(b).

The position of the stylus 10 can be sensed by the sensing unit (140 of FIG. 1) of the mobile terminal 100, the sensing unit (41 of FIG. 7) included in the stylus 10 and/or the RF communication unit (31 of FIG. 7). For example, when the stylus 10 is located on the display 151, the position of the stylus 10 can be sensed through the touch sensor of the display 151 of the mobile terminal 100. Furthermore, if the stylus 10 is not moved and pressure is not sensed through the touch sensor of the display 151, the controller 180 can determine that the stylus 10 is located out of the display 151.

The controller 180 may control the mobile terminal 100 to perform different operations according to positions of the stylus 10. The operations of the mobile terminal 100 will now be described in detail.

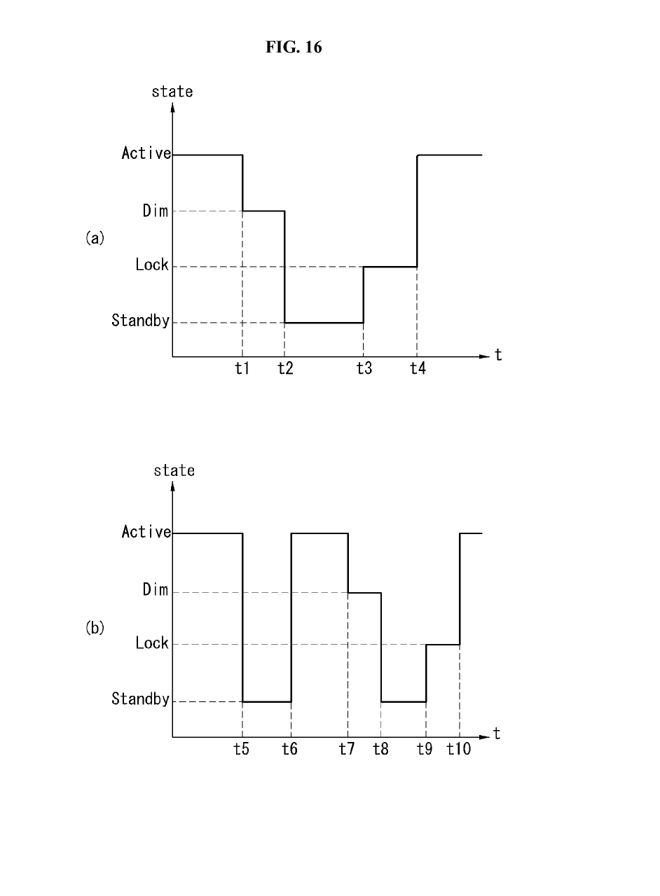

Referring to FIG. 16, the mobile terminal 100 may be in specific states including an active state, a dim state, a lock state and a standby state.

The active state may be a state in which the mobile terminal 100 is activated such that the user can use the mobile terminal 100.

The dim state may be a state in which a backlight (not shown) is turned off because a user input is not applied for a predetermined time. That is, the controller 180 can turn the backlight (not shown) off to reduce battery consumption when the user does not apply an input for a predetermined time.

The lock state may be a state in which access to the mobile terminal 100 is restricted. For example, when the mobile terminal 100 is manipulated after the lapse of a predetermined time, a lock screen may be display in order to prevent wrong manipulation. The mobile terminal 100 can enter the active state when the user performs a predetermined manipulation on the lock screen.

The standby state may be a state the display 151 is turned off since the user does not apply an input for a predetermined time or longer. If the user manipulates a power button of the mobile terminal 100 in the standby state, the backlight (not shown) may be operated. In this case, the controller 180 of the mobile terminal 100 can directly change the standby state to the active state without passing through the lock state according to a user gesture. Accordingly, an additional operation for canceling the lock screen may not be needed.

Referring to FIG. 16(a), the mobile terminal 100 can be changed from a specific state to the next state. For example, the mobile terminal 100 may be in the active state until t1.

The mobile terminal 100 may enter the dim state at t1. For example, the mobile terminal 100 enters the dim state at t1 since the mobile terminal 100 is not manipulated for a predetermined time or longer.

The mobile terminal 100 may enter the standby state at t2. That is, the display 151 of the mobile terminal 100 may be turned off at t2.

The mobile terminal 100 may enter the lock state at t3. For example, the lock screen can be displayed although the power button of the mobile terminal 100 is manipulated to turn the display 151 on.

The mobile terminal 100 may enter the active state at t4. That is, the user cancels the lock screen at t4.

In a conventional mobile terminal, state change is carried out through a specific state. For example, the conventional mobile terminal should pass the dim state to be changed from the active state to the standby state if the user does not directly manipulate the power button. Furthermore, the conventional mobile terminal should pass through the lock state to be changed from the standby state to the active state. The mobile terminal should also pass through the lock state when the user turns on the mobile terminal by manipulating the power button. Since the conventional mobile terminal needs to pass through a specific middle state to be changed from the current state to a final state, the user of the conventional mobile terminal has to perform an additional operation.

As shown in FIG. 16(b), the controller 180 of the mobile terminal 100 according to an embodiment of the present invention can be changed to the standby state from the active state at t5. That is, the mobile terminal 100 can be directly changed to the standby state from the active state without passing through the dim state. Direct change from the active state to the standby state can be performed when the user makes a specific gesture of manipulating the stylus 10. For example, when the mobile terminal 10 can be changed from the active state to the standby state when the user puts down the stylus 10 on the display 151 of the mobile terminal 100.

The standby state may be changed to the active state at t6. That is, the mobile terminal 100 can be directly changed from the standby state to the active state without passing through the lock state. Direct change to the active state from the standby state may be performed when the user makes a specific gesture of manipulating the stylus 10. For example, the standby state can be changed to the active state when the user puts down the stylus 10 by the mobile terminal 100.

The active state can be changed to the dim state at t7. Change to the dim state from the active state may be performed when the user manipulates the stylus 10 in a specific way. That is, the mobile terminal 100 can be changed from the active state to the dim state when the user makes a specific gesture of manipulating the stylus 10 while the conventional mobile terminal is changed from the active state to the dim state after the lapse of a predetermined time when a user input is not applied. Accordingly, it is possible to use the mobile terminal 100 more efficiently to reduce battery consumption. Change to the dim state from the active state may be performed when the user puts down the stylus 10 on an area other than the mobile terminal 100. That is, change to the dim state from the active state can be carried out according to a user gesture different from the user gesture for change from the active state to the standby state. Since a user gesture can reflect an intention of the user, the user can use the mobile terminal 100 more intuitively and effectively by manipulating the mobile terminal 100 according to a user gesture.

The dim state may be changed to the standby state at t8.

The standby state may be changed to the lock state at t9. In this case, the lock screen may be displayed. The lock screen may be displayed differently according to gestures of manipulating the stylus 10. For example, the lock screen can be displayed in such a manner that the lock screen corresponds to a direction in which the stylus 10 is gripped. Accordingly, the lock screen can be cancelled more conveniently.

The lock state can be changed to the active state at t10. That is, the lock screen can be cancelled using the stylus 10 to change the lock state to the active state.

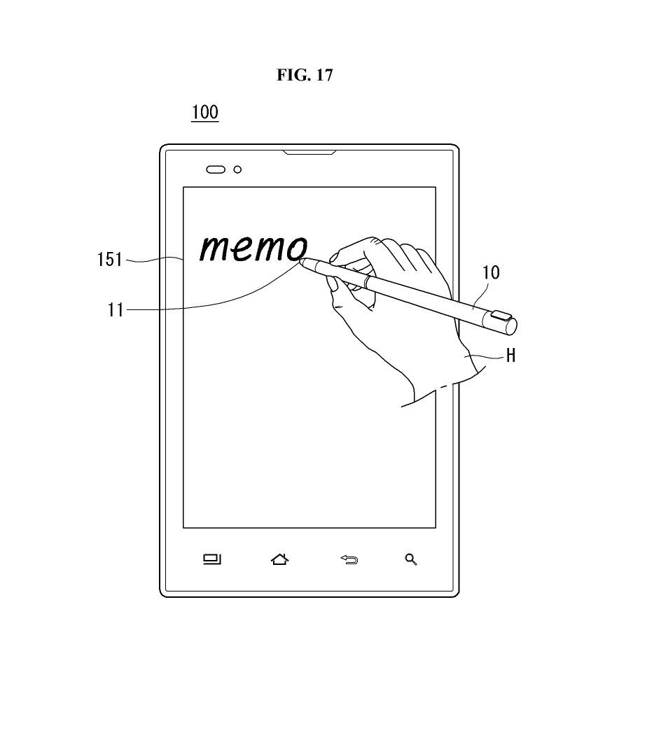

Referring to FIG. 17, the user can apply an input using the stylus 10.

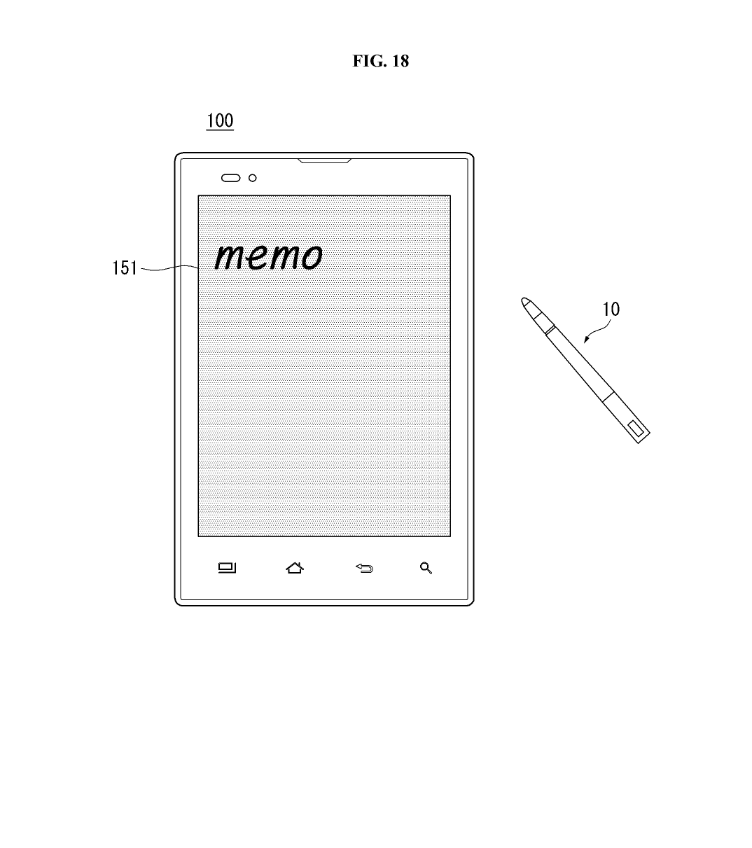

Referring to FIG. 18, the user may put down the stylus 10 on an area other than the display 151 of the mobile terminal 100. This user gesture can be sensed by the sensing unit (41 of FIG. 7) of the stylus 10 and/or the sensing unit (140 of FIG. 1) of the mobile terminal 100, as described above.

The controller 180 may control the mobile terminal 100 to enter the dim state upon sensing that the stylus 10 is put down on an area other than the display 151. For example, the controller 180 can turn off the backlight (not shown) that illuminates the display 151. According to an embodiment of the present invention, the time when the mobile terminal 100 enters the dim state may not be related to the time when the mobile terminal 100 is manipulated. That is, the mobile terminal 100 may not enter the dim state when the mobile terminal 100 is not manipulated for a predetermined time. According to an embodiment of the present invention, the mobile terminal 100 can enter the dim state when the user makes a gesture of manipulating the stylus 10. Accordingly, it is possible to minimize power consumed to turn the backlight (not shown) on for a predetermined time until the mobile terminal 100 enters the dim state. Furthermore, the user gesture can effectively reflect the user's intention of not manipulating the mobile terminal 100 any more.

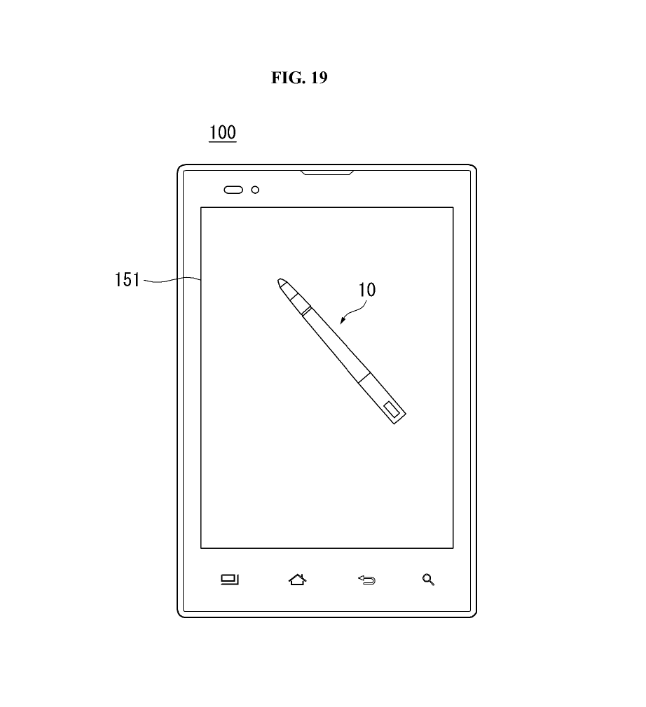

Referring to FIG. 19, the user may put down the stylus 10 on the display 151. When the stylus 10 is put down on the display 151, the controller 180 can control the mobile terminal 100 to enter the standby state. In case of the conventional mobile terminal, a predetermined period time should pass in the dim state or the user should directly manipulate the power button to control the conventional mobile terminal to enter the standby state. However, the mobile terminal 100 according to an embodiment of the present invention can enter the standby state without lapse of additional time or additional operation. In addition, since the mobile terminal 100 enters the standby state according to a gesture of manipulating the stylus 10, the user can manipulate the mobile terminal 100 more intuitively.

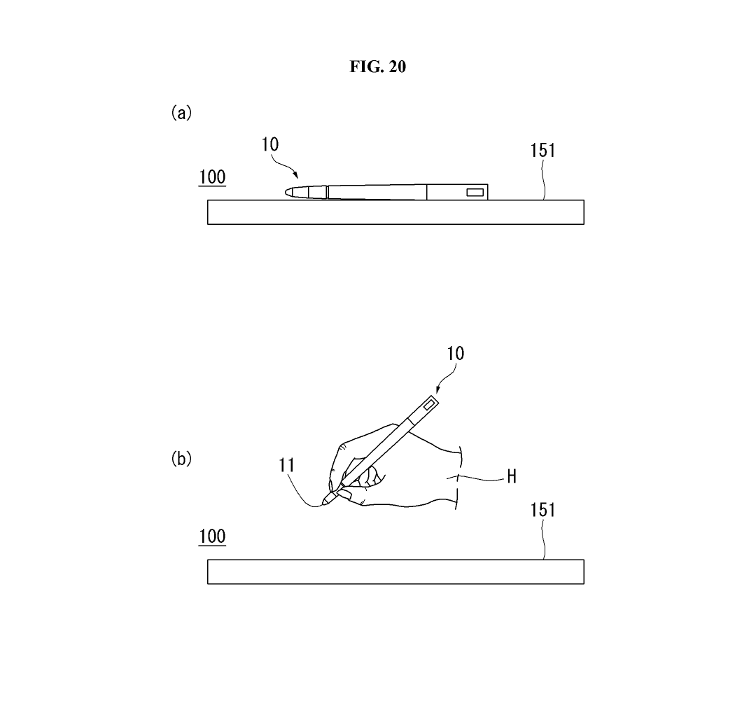

Referring to FIG. 20(a), when the user puts down the stylus 10 on the display 151, the controller 180 can control the mobile terminal 100 to enter the standby state.

Referring to FIG. 20(b), the user may grip and lift the stylus 10 in the standby state of the mobile terminal 100. At this time, the user may grip the stylus 10 such that the tip 11 of the stylus 10 points the display 151. That is, it is possible to predict that the user will perform a specific operation using the stylus 10 from the gesture.

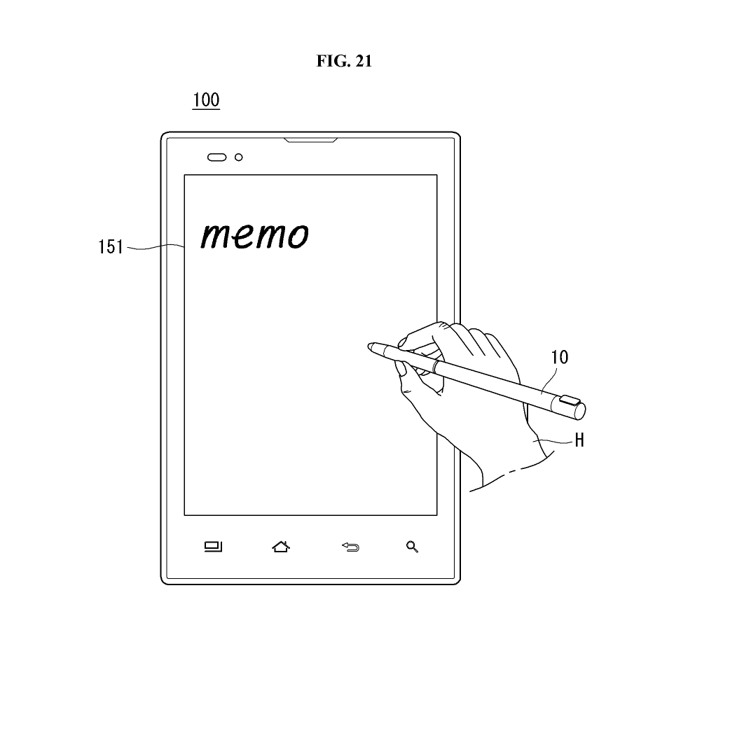

Referring to FIG. 21, when the user lifts the stylus 10, the controller 180 can control the mobile terminal 100 to enter the active state. That is, the mobile terminal 100 can be directly changed to the active state from the standby state without passing through the lock state. This may be considered that the user's intention of using the mobile terminal 100 is reflected in the gesture of lifting the stylus 10. That is, the mobile terminal 100 can be changed to the state in which the user can immediately use the mobile terminal 100 without an additional manipulation, and thus the user can manipulate the mobile terminal 100 intuitively and immediately.

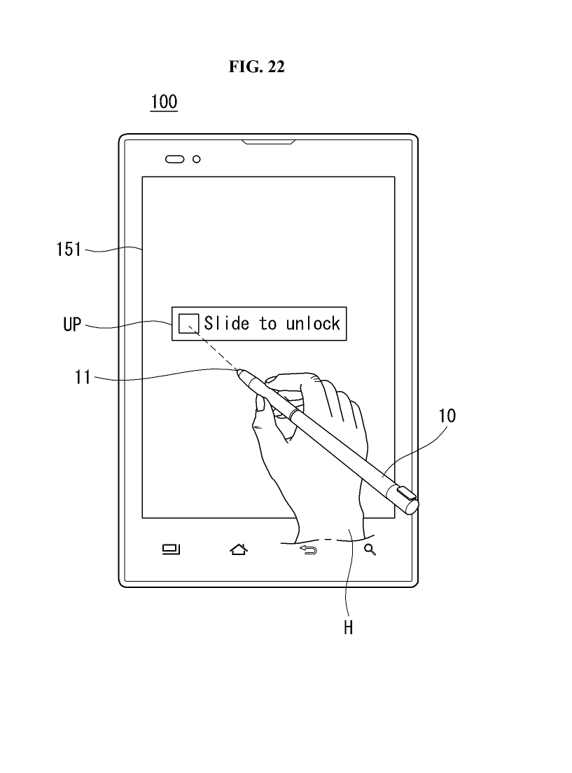

FIGS. 22 to 26 illustrate an unlock function of the mobile terminal of FIG. 1 according to a gesture of manipulating the stylus.

As shown in FIGS. 22 to 26, the controller 180 of the mobile terminal 100 may display a lock screen unlock window UP corresponding to a user gesture of manipulating the stylus 10.

Referring to FIG. 22, the user may make a gesture of gripping the stylus 10.

When the user grips the stylus 10, the controller 180 can sense the gesture of gripping the stylus 10. Furthermore, the controller 180 can sense the orientation of the stylus 10 gripped by the user. Even if the tip 11 of the stylus 10 does not directly come into contact with the display 151, the controller 180 can display the lock screen unlock window UP at a region closest to the tip 11 of the gripped stylus 10. The gesture of gripping the stylus 10 can reflect the user's intention of using the mobile terminal 100. Accordingly, the lock screen unlock window UP can be displayed near the tip 11 of the stylus 10 such that the user can use the mobile terminal 100 more rapidly and conveniently.

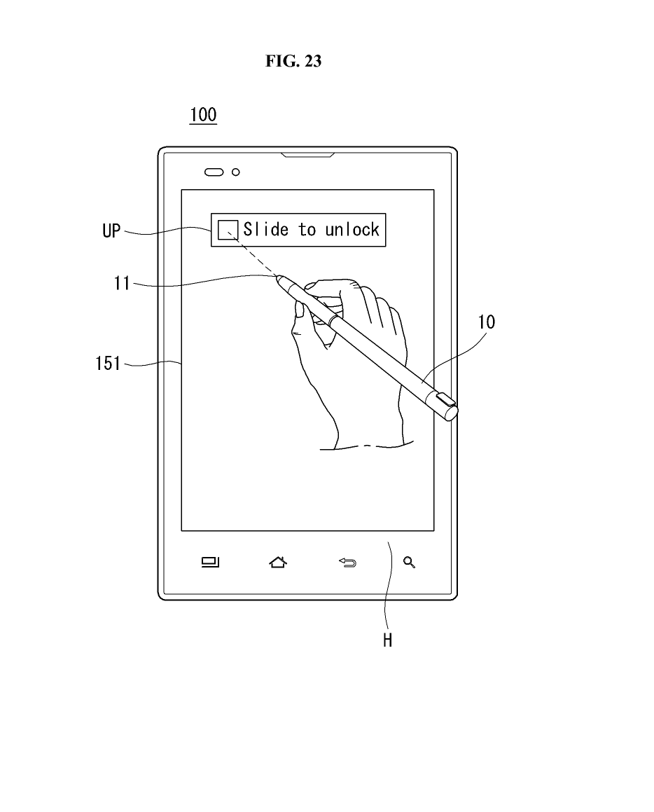

Referring to FIG. 23, when the position of the stylus 10 gripped by the user is changed, the location of the lock screen unlock window UP is also changed such that the lock screen unlock window UP corresponds to the tip 11 of the stylus 10.

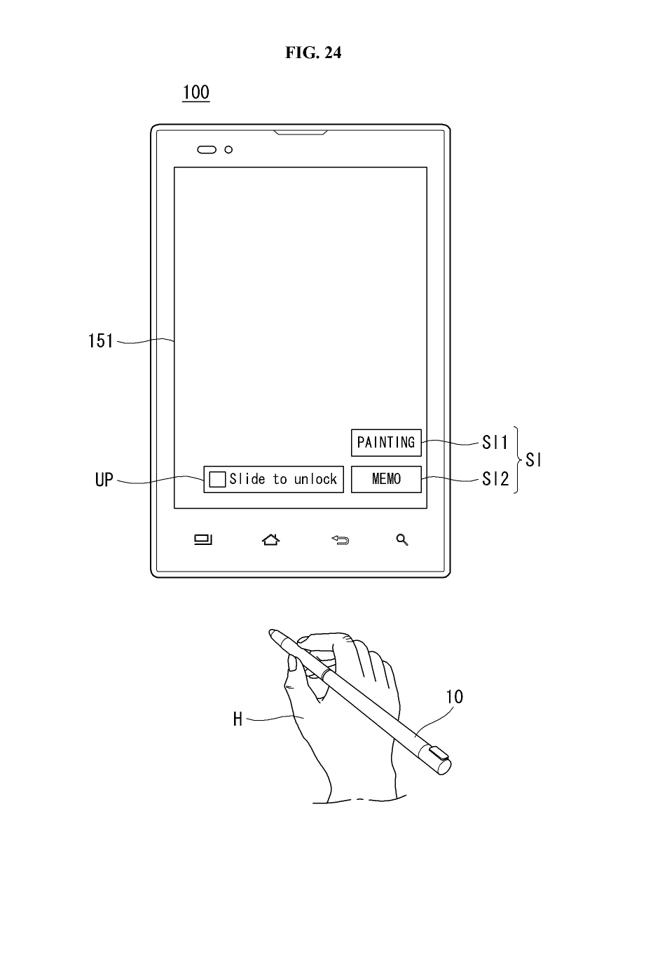

Referring to FIG. 24, when the user grips the stylus 10, a shortcut icon SI may be displayed. The shortcut icon SI may be an icon corresponding to an application that can execute a function without cancelling the lock screen. For example, a first shortcut icon SI1 corresponding to a painting function and a second shortcut icon SI2 corresponding to a memo function can be displayed.

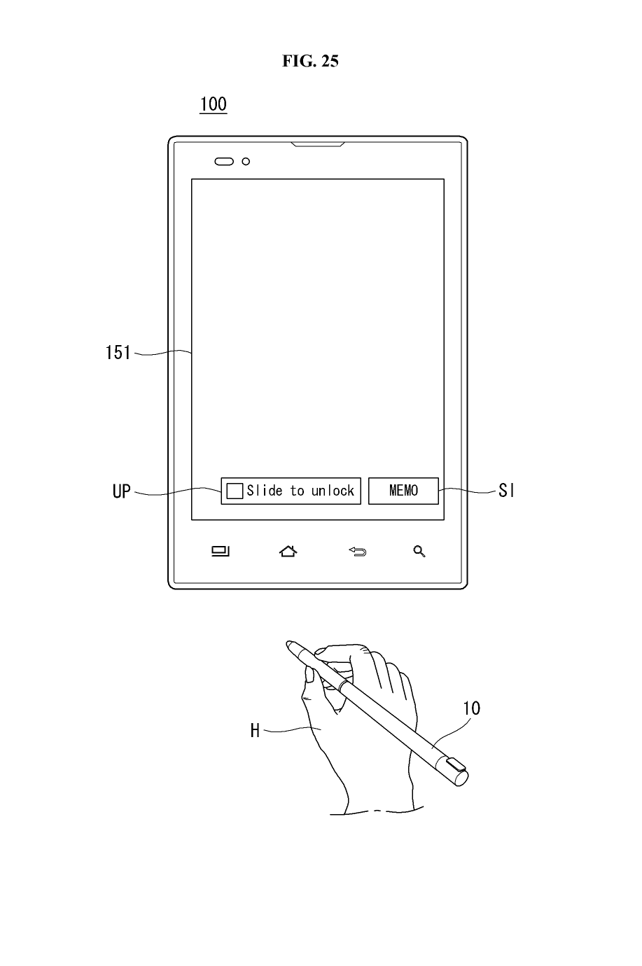

Referring to FIG. 25, when the user grips the stylus 10, a different shortcut icon SI may be displayed. In this case, the shortcut icon SI may be an icon corresponding to a specific function executed before the mobile terminal 100 enters the standby state or the lock state. For example, if the mobile terminal 100 enters the standby state or the lock state during execution of the memo function, the memo function can be directly executed through the shortcut icon SI.

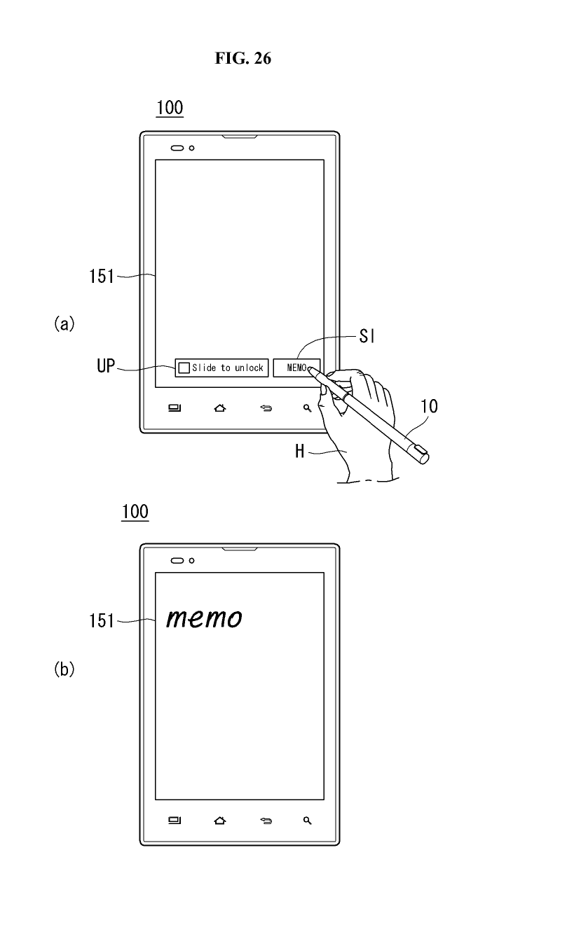

Referring to FIG. 26(a), the user may select the displayed shortcut icon SI.

Referring to FIG. 26(b), upon selection of the shortcut icon SI by the user, the memo screen previously executed can be displayed on the display 151 without an additional operation of selecting the lock screen unlock window UP.

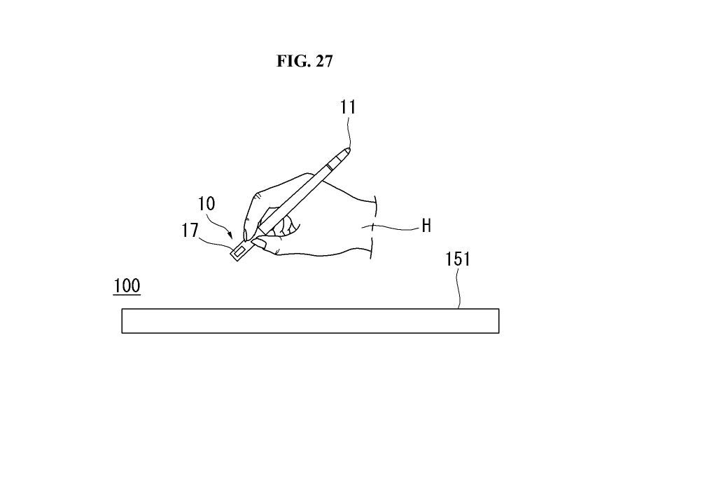

FIGS. 27 to 29 illustrate a delete function of the mobile terminal of FIG. 1 according to a gesture of manipulating the stylus.

As shown in FIGS. 27 to 29, the controller 180 of the mobile terminal 100 may execute a function corresponding to a gesture of holding the stylus 10 upside down.

Referring to FIG. 27, the user can hold the stylus 10 upside down. That is, the user can grip the stylus 10 in such manner that the rear portion 177 of the stylus 10 points the display 151. The gesture of holding the stylus 10 upside down can correspond to a gesture of holding a pencil with an eraser attached to the backend thereof upside down. This may represent that the user intends to delete content written by the pencil.

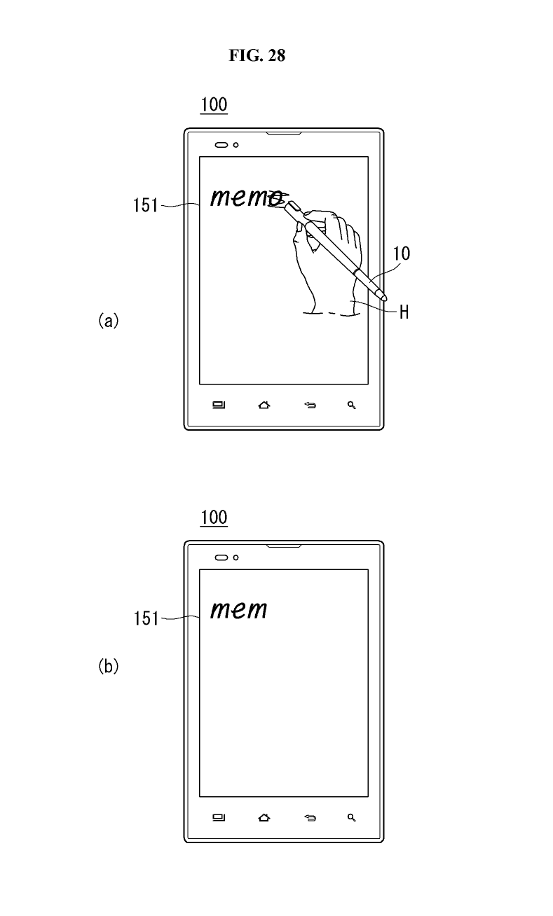

Referring to FIG. 28(a), the user may make a gesture of erasing the previously input memo with the stylus 10 gripped upside down. For example, the user can make an erase gesture EC of moving the stylus 10 from side to side or up and down in a specific area.

Referring to FIG. 28(b), when the user makes the erase gesture EC, the controller 180 can erase display of the area corresponding to erase gesture E.

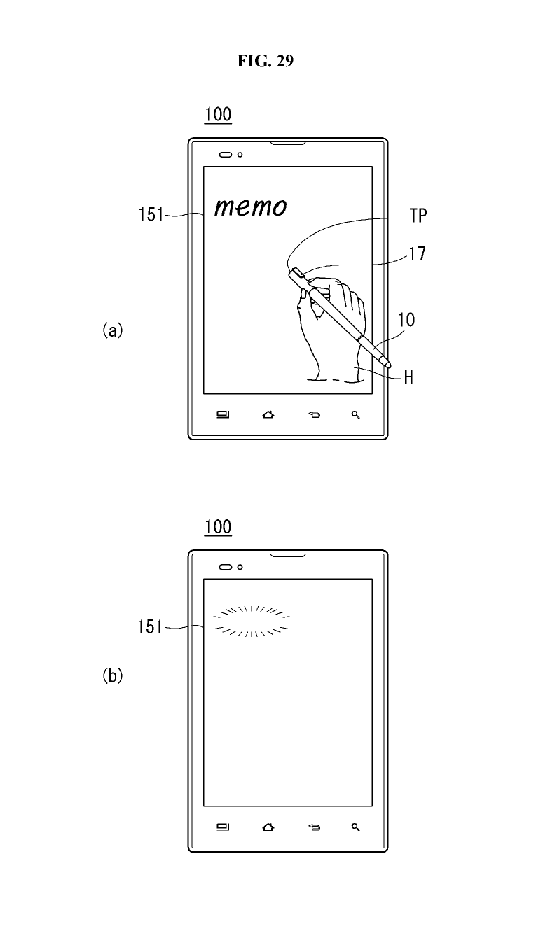

Referring to FIG. 29(a), the user can touch a specific point of the display 151 with the stylus 10 gripped upside down. For example, the user can long-touch the specific point of the display 151 with the rear portion 17 of the stylus 10.

Referring to FIG. 29(b), when the user long-touches the specific point of the display 151 with the rear portion 17 of the stylus 10, the memo displayed on the display 151 can be erased at a time.

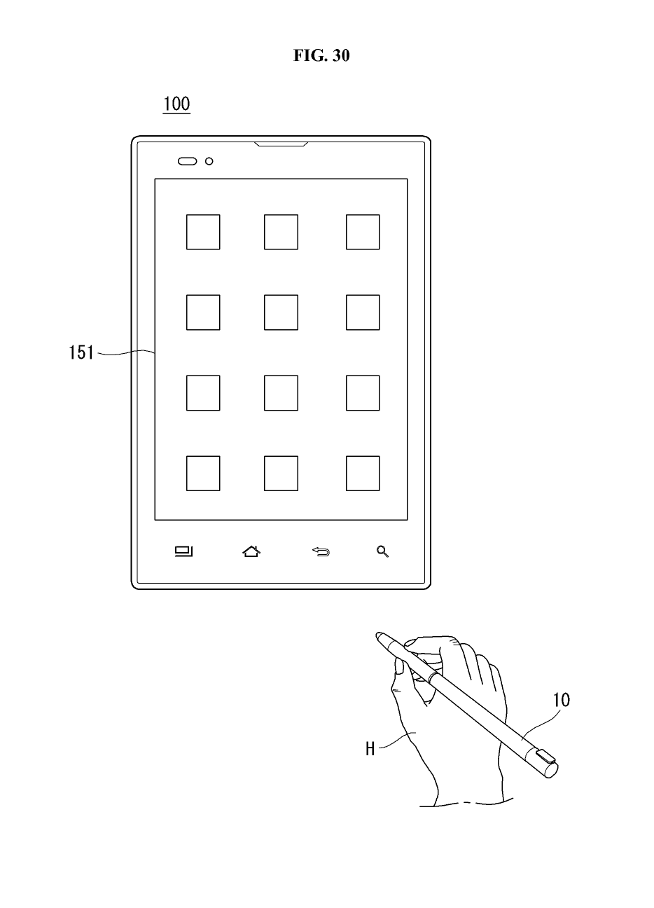

FIGS. 30 to 34 illustrate a memo function of the mobile terminal of FIG. 1 according to a gesture of manipulating the stylus.

Referring to FIG. 30, the display 151 of the mobile terminal 100 may display a specific screen. For example, the display 151 may display a back screen of the mobile terminal 100.

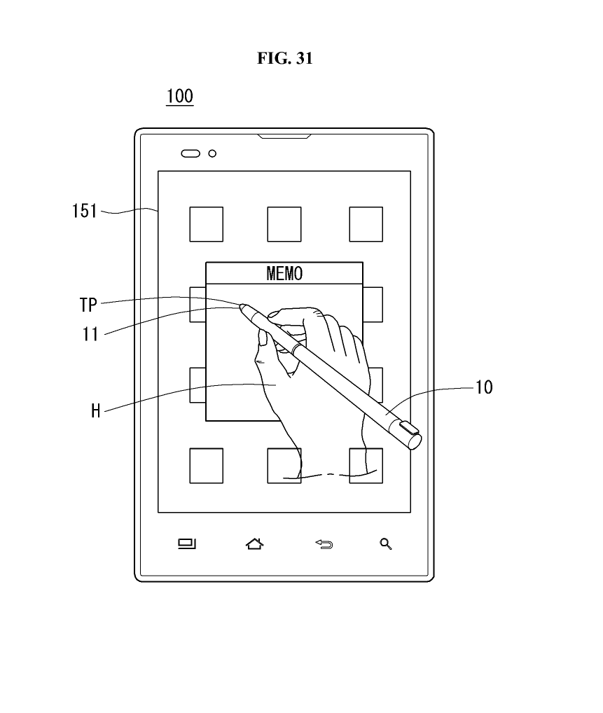

Referring to FIG. 31, when the user grips the stylus 10 and moves the stylus 10 to the display 151, the controller 180 can execute a quick memo function. That is, the controller 180 can execute a function of writing a memo using the stylus 10 without performing an additional operation of selecting a memo function. For example, when the user makes a gesture of gripping the stylus 10 and moving the stylus 10 to the display 151, the quick memo function can be executed. The memo function using the stylus 10 can be performed on a point recognized as a touch point TP by the tip 11.

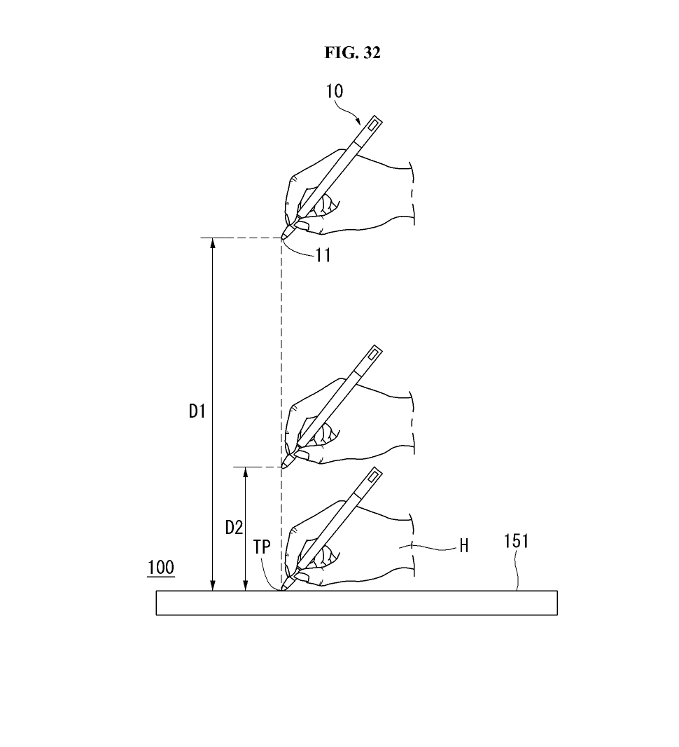

Referring to FIG. 32, the quick memo function can be executed when the tip 11 of the stylus 10 is positioned at a predetermined distance from the display 151. For example, the quick memo function can be indicated when the tip 11 approaches the display 151 by first distance D1. When the tip 11 approaches the display 151 by a second distance D2, a trajectory corresponding to the gesture of moving the tip 17 can be displayed on a memo window. That is, the memo function can be executed when the tip 17 and the display 151 comes into contact with each other and/or when the tip 17 is positioned within a predetermined distance from the display 151.

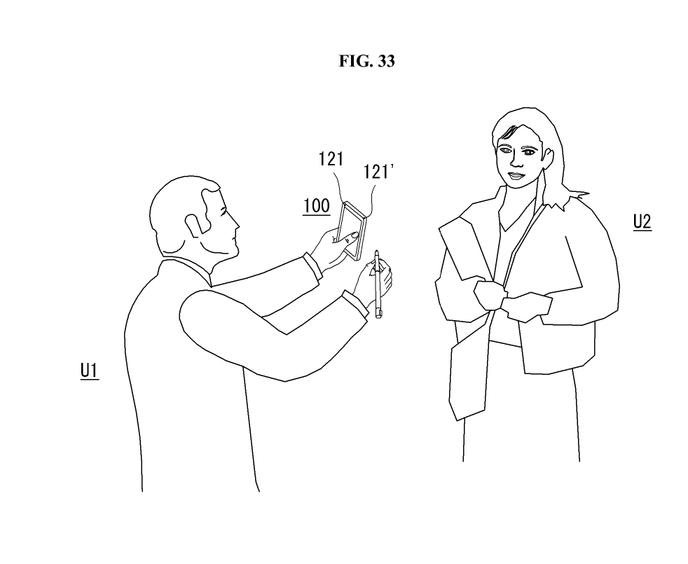

Referring to FIG. 33, a first user U1 can take an image of a second user U2 using the camera 121′.

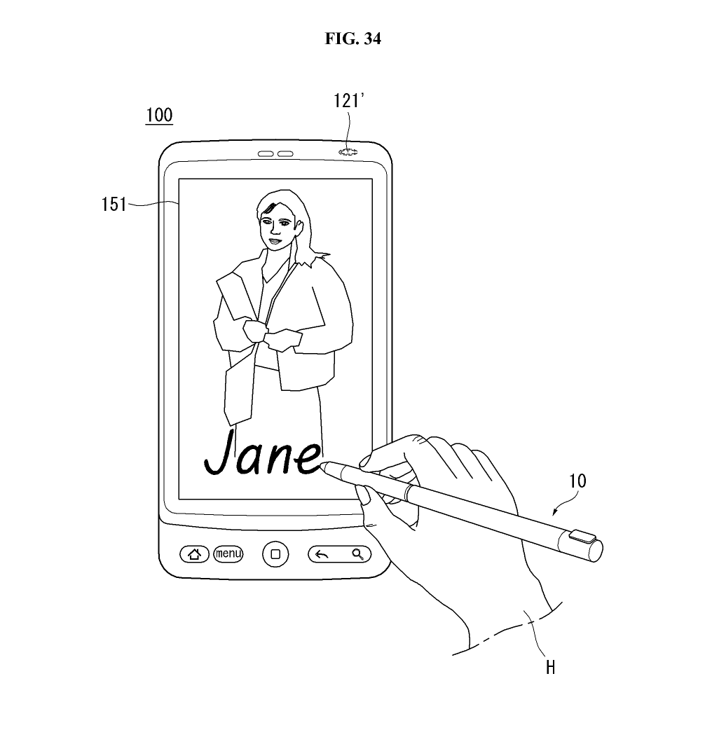

Referring to FIG. 34, the first user U1 who photographs the second user U2 can write a note on the image captured or being captured using the stylus 10. The note input by the user can be stored. For example, the note of the user can be used as a tag of the image, used as a file name of the stored image, or stored as an image.

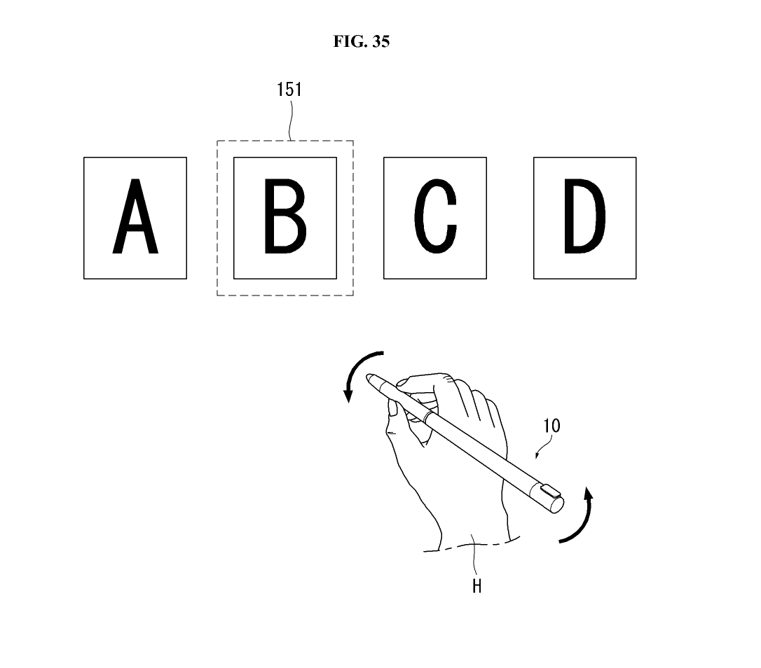

FIGS. 35 to 39 illustrate a scroll function of the mobile terminal of FIG. 1 according to a gesture of manipulating the stylus.

As shown in FIGS. 35 to 39, the user can spin the stylus 10. For example, the user can spin the stylus 10 in a hand H like pen spinning.

Referring to FIG. 35, image B may be displayed on the display 151. Images A, C and D may be previous and next images of image B although images A, C and D are not currently displayed on the display 151. The user can spin the stylus 10 in the hand H. For example, the user can spin the stylus 10 counterclockwise.

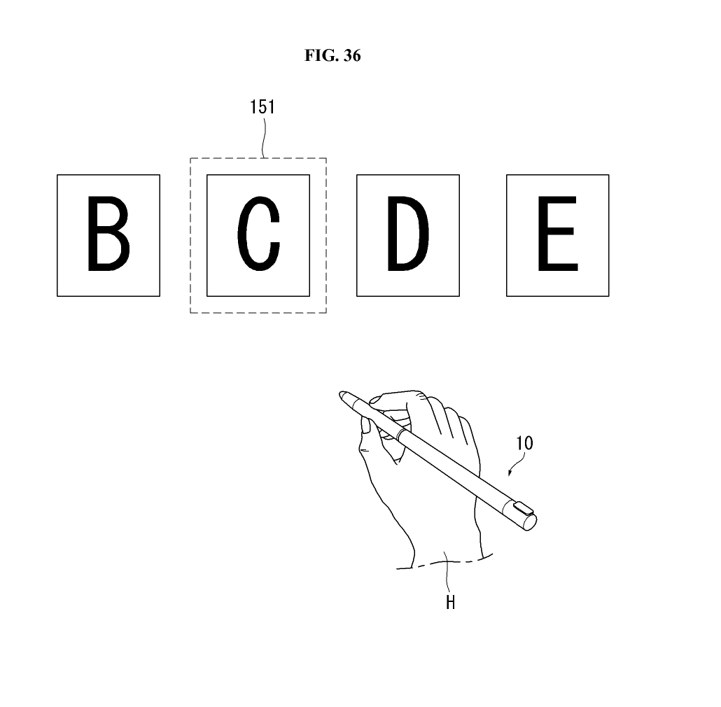

Referring to FIG. 36, when the stylus 10 spins, the image displayed on the display 151 can be changed. For example, image B can be changed to image C.

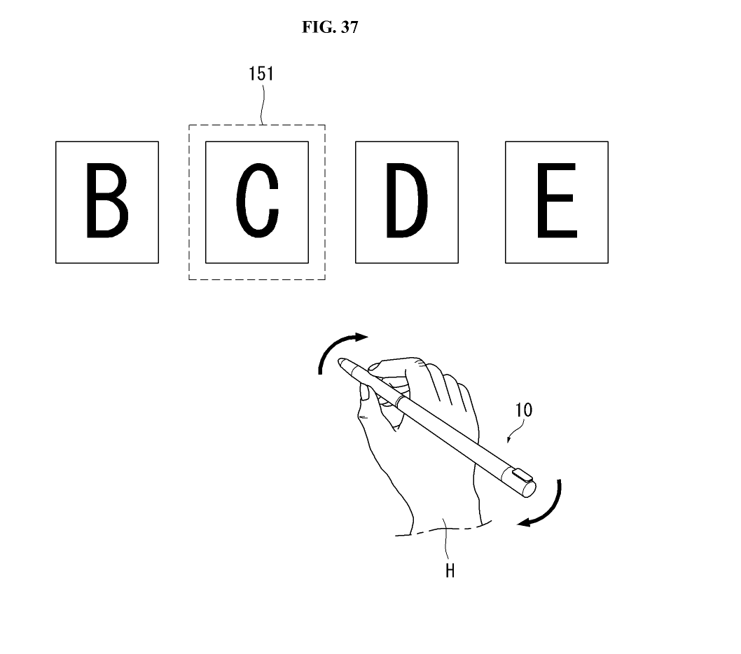

Referring to FIG. 37, the user can spin the stylus 10 in the opposite direction. For example, the user can spin the stylus 10 clockwise.

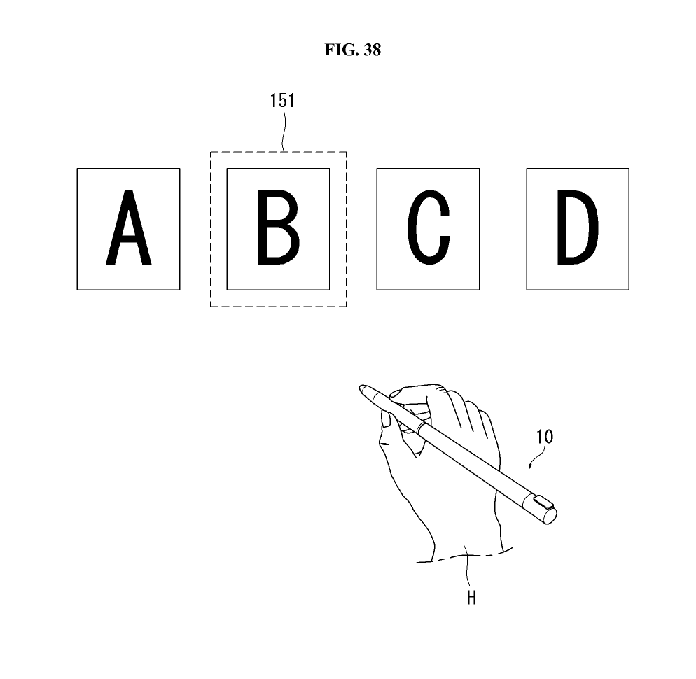

Referring to FIG. 38, when the user spins the stylus 10 in the opposite direction, the controller 180 can display the initial image on the display 151. That is, an image can be displayed in one direction or opposite direction according to a spinning direction of the stylus 10.

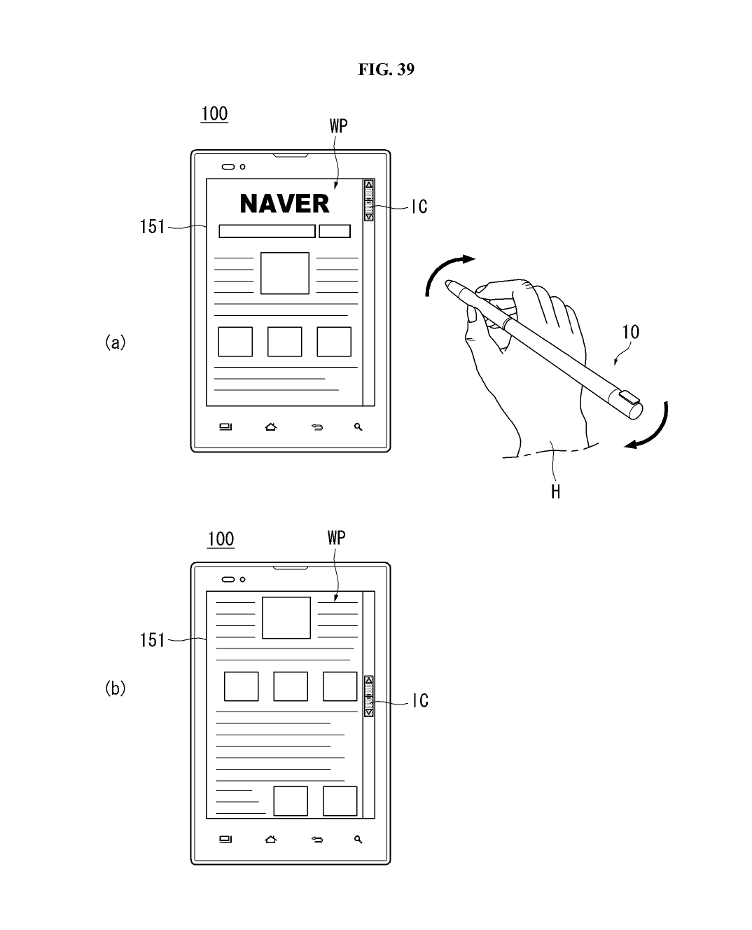

Referring to FIG. 39(a), the display 151 may display a web page WP. The web page WP may be scrolled. The user can scroll the web page WP by directly touching a scrolling bar IC. Furthermore, the user can scroll the web page WP by manipulating the stylus 10.

Referring to FIG. 39(b), when the stylus 10 spins, the controller 180 can scroll the web page WP in response to spinning of the stylus 10. If the stylus 10 spins in the opposite direction, the web page WP can be scrolled in the opposite direction.

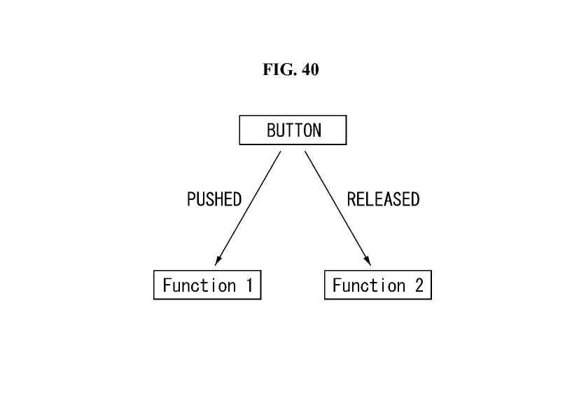

FIG. 40 illustrates selection of a function of the mobile terminal of FIG. 1 according to operation of pushing the stylus.

As shown in FIG. 40, the controller 180 of the mobile terminal 100 may control the mobile terminal 100 to perform a specific operation when a button provided to the stylus 10 is manipulated. For example, the controller 180 can execute a first function when the button provided to the stylus 10 is pushed and execute a second function when the button is released. For example, the first and second functions may be related to the quick memo function. That is, the quick memo function can be executed when the button is pushed and the quick memo function is cancelled when the button is released.

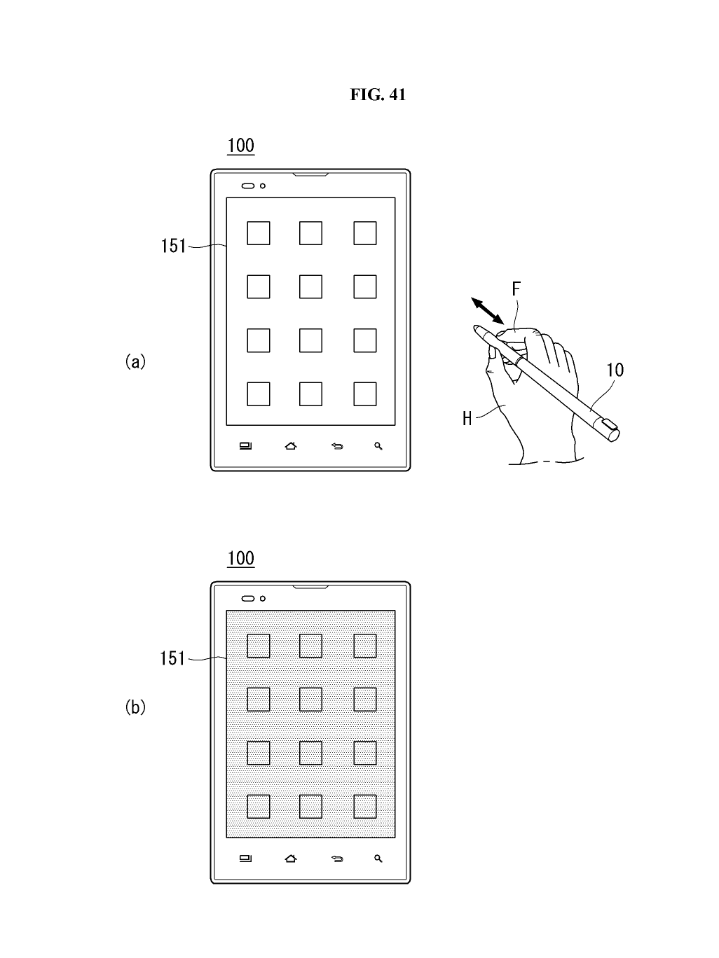

FIG. 41 illustrates a function corresponding to an operation of rubbing the stylus of the mobile terminal of FIG. 1.

As shown in FIG. 41, the controller 180 of the mobile terminal 100 can execute a function corresponding to a gesture of rubbing the stylus 10.

Referring to FIG. 41(a), the display 151 may be displayed in a predetermined brightness and/or color. The user may make a gesture of rubbing the body of the stylus 10. For example, the user can move a finger F up and down on the body of the stylus 10.

Referring to FIG. 41(b), when the user makes a gesture of rubbing the stylus 10, the controller 180 can change the brightness and/or color of the display 151 according to the gesture. For example, the controller 180 can make the display 151 brighter or darker or change the color of the display 151. In this case, the controller 180 can linearly change the brightness and/or color of the display 151 according to a degree by which the user rubs the stylus 10.

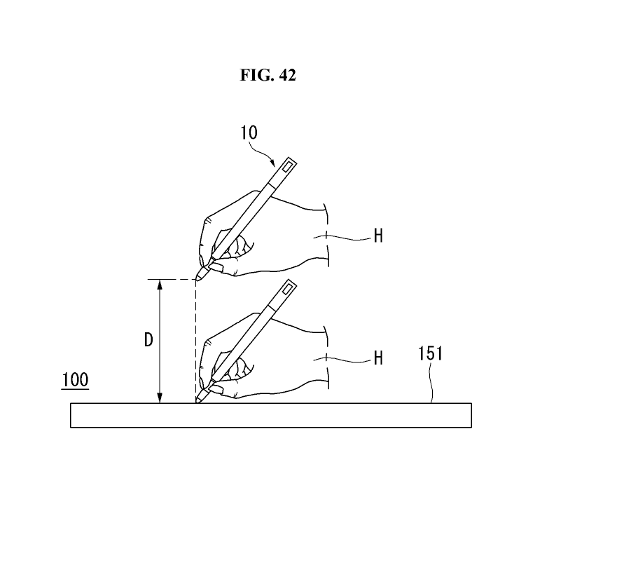

FIGS. 42 to 44 illustrate an operation of the mobile terminal of FIG. 1 according to a distance between the stylus and the display of the mobile terminal.

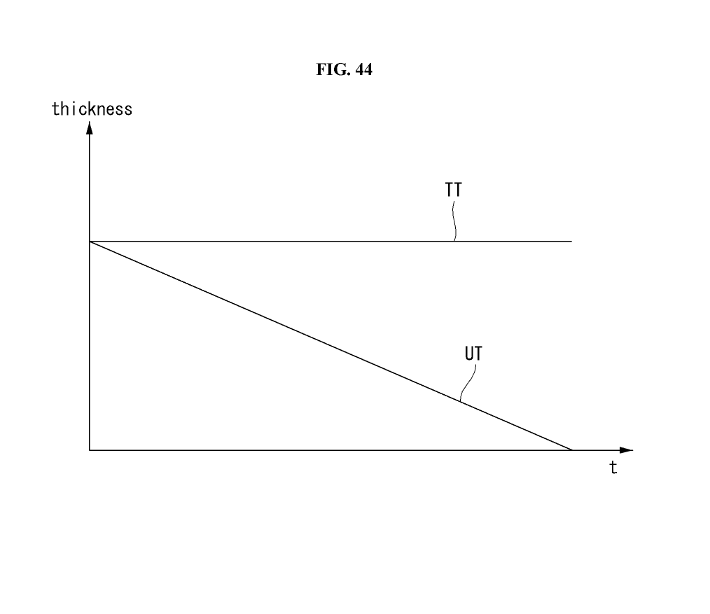

As shown in FIGS. 42 and 44, the controller 180 of the mobile terminal 100 may change at least one of the thickness, brightness and duration of a trajectory displayed on the display 151 on the basis of a distance between the display 151 and the stylus 10.

Referring to FIG. 42, a distance D between the stylus 10 gripped by the user and the display 151 may change. For example, the stylus 10 can be positioned at a predetermine distance from the display 151 or can come into contact with the display 151.

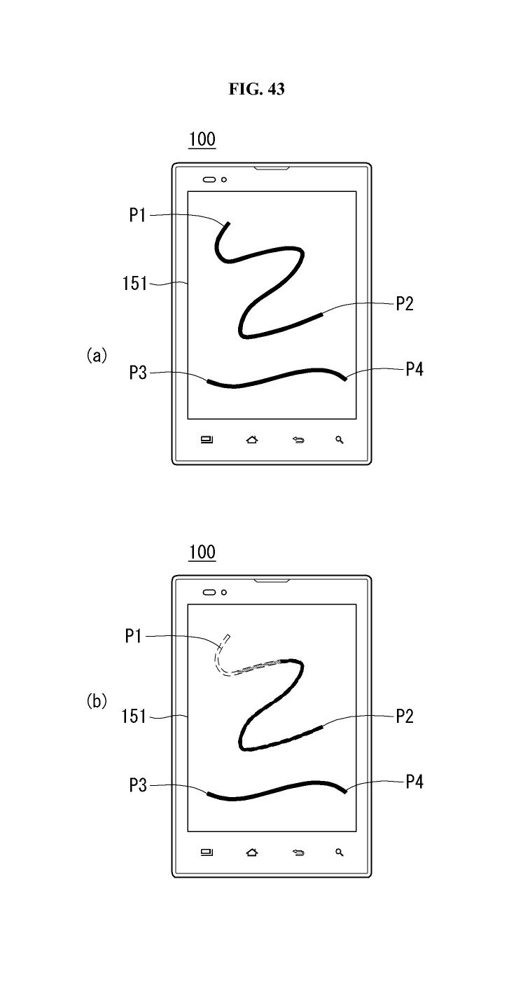

Referring to FIG. 43(a), trajectories may be displayed on the display 151 at a specific time. A trajectory P1-P2 may correspond to a gesture made when the stylus 10 is located at a distance from the display 151. A trajectory P3-P4 may correspond to a gesture made when the stylus 10 comes into contact with the display 151. The trajectories P1-P2 and P3-P4 may have different thicknesses and brightnesses even when initially displayed. For example, the trajectory P3-P4 can be darker than the trajectory P1-P2.

Referring to FIG. 43(b) the trajectory P1-Pw displayed when the stylus 10 is separated from the display 151 may gradually become dim as time passes. The controller 180 can make the trajectory P1-P2 disappear from the display 151 after lapse of a predetermined time. Accordingly, the user can sketches an image on the display 151 by moving the stylus 10 without bringing the stylus 10 into contact with the display 151 and then display a desired touch trajectory by moving the stylus along the sketched trajectory. The sketched image disappears after lapse of a predetermined time even when an additional operation is not performed, and thus the user can freely sketch images until a desired trajectory is acquired.

Referring to FIG. 44, a first touch trajectory TT according to directly touch of the stylus 10 and the display 151 can maintain a predetermined thickness regardless of lapse of time. On the contrary, the thickness of a second touch trajectory UT displayed without direct touch of the stylus 10 and the display 151 may decrease with lapse of time. Accordingly, the second touch trajectory TT may disappear from the display 151 after lapse of a predetermined time.

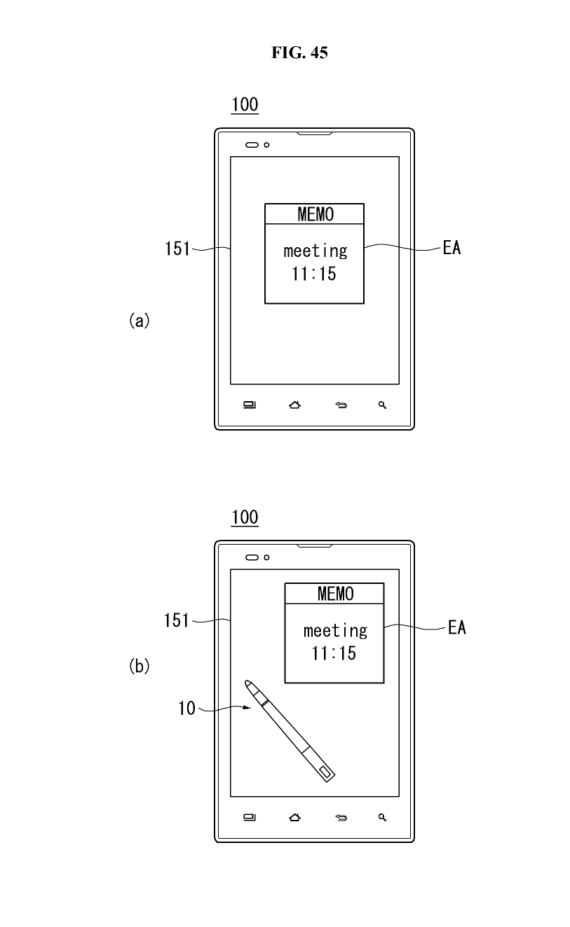

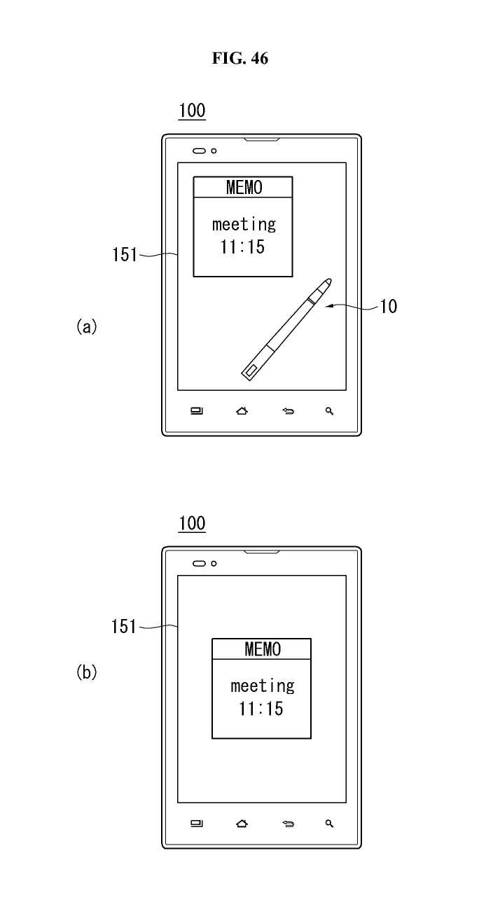

FIGS. 45 and 46 illustrate an operation of the mobile terminal of FIG. 1 according to location of the stylus.

As shown in FIGS. 45 and 46, the controller 180 of the mobile terminal 100 may change location of a displayed image such that the image is not covered with the stylus 10.

Referring to FIG. 45(a), a memo EA may be displayed on the display 151.

Referring to FIG. 45(b), the user may make a gesture of putting down the stylus 10 at one side of the display 151. The controller 180 can sense the location of the stylus 10 on the display 151. The controller 180 can change the position of the memo EA such that the stylus 10 is not positioned on the memo EA upon sensing the location of the stylus 10.

Referring to FIG. 46(a), the user can change the location of the stylus 10. Upon change of the location of the stylus 10, the location of displayed information may be changed.

Referring to FIG. 46(b), when the stylus 10 is removed from the display 151, the displayed information can be displayed in the initial position.

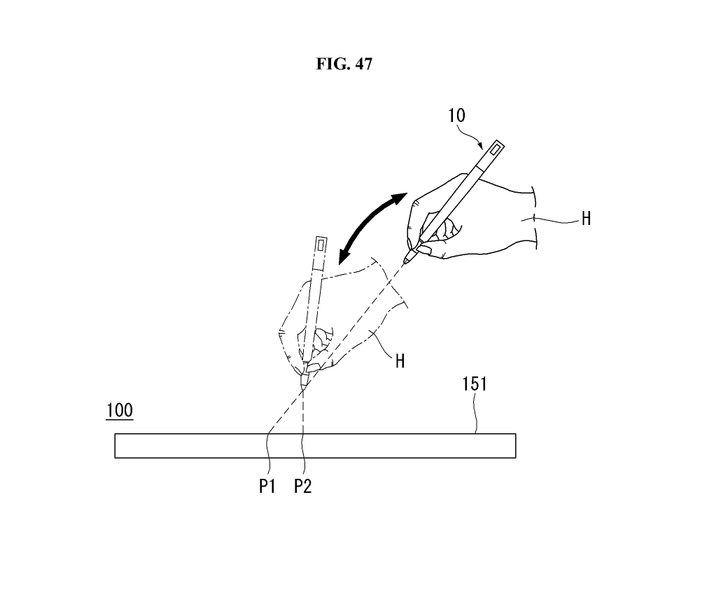

FIGS. 47 to 50 illustrate a function corresponding to an operation of shaking the stylus of the mobile terminal of FIG. 1.

As shown in FIGS. 47 to 50, the controller 180 of the mobile terminal 100 can execute a function corresponding to a gesture of shaking the stylus 10.

Referring to FIG. 47, the user can shake the gripped stylus 10 up and down. Here, the orientation of the stylus 10 may correspond to a first position P1 and a second position P2 according to positions of the shaken stylus 10.

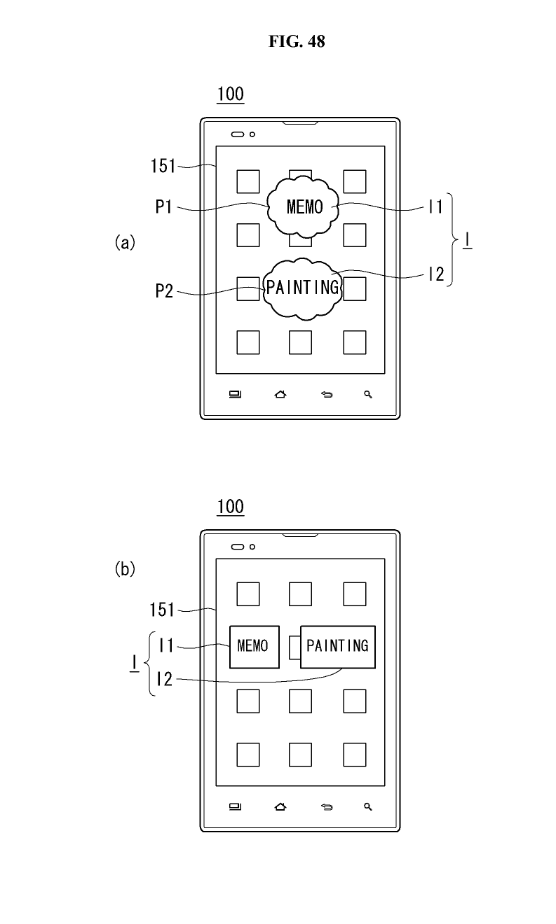

Referring to FIG. 48(a), the control 180 can respectively display first and second icons I1 and 12 in the first and second positions P1 and P2 according to the gesture of shaking the stylus 10. The first and second icons I1 and 12 may be icons I corresponding to functions executable using the stylus 10. It is possible to express the first and second icons I1 and 12 as if water drops so as to represent that the first and second icons I1 and 12 are displayed in response to the gesture of shaking the stylus 10.

Referring to FIG. 48(b), the icons I corresponding to the gesture of shaking the stylus 10 may be displayed in a predetermined size.

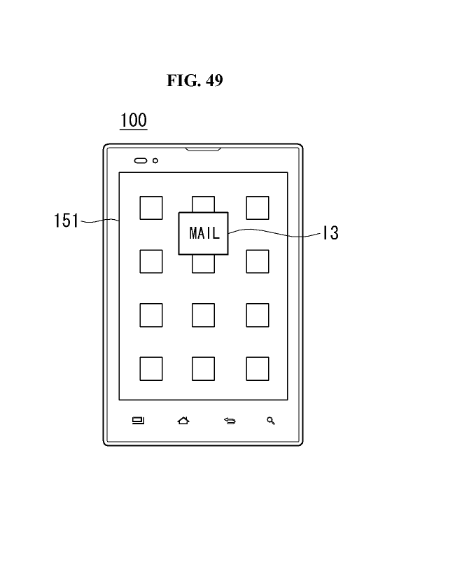

Referring to FIG. 49, when the user makes the gesture of shaking the stylus 10, a third icon 13 corresponding to a function recently executed using the stylus 10 may be displayed.

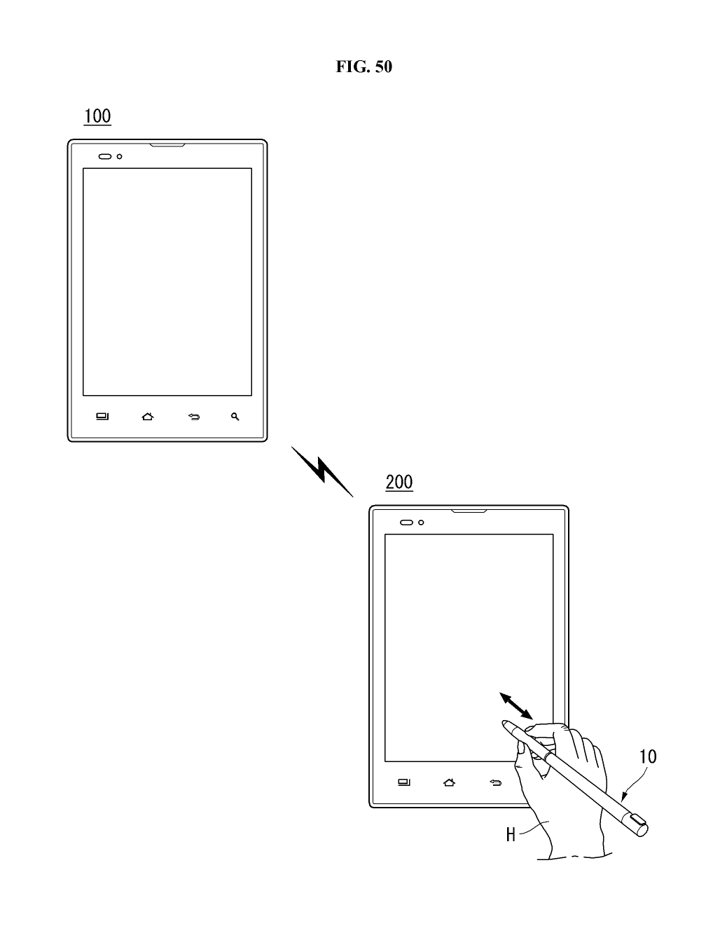

Referring to FIG. 50, when the user makes the gesture of shaking the stylus 10, the controller 180 may transmit information to a specific device 200. For example, when the user shakes the stylus 10 above the specific device 200, the controller 180 of the mobile terminal 100 can transmit specific information of the mobile terminal 100 to the specific device 200. That is, a gesture of manipulating the stylus 10 can specify a target to which information will be transmitted.

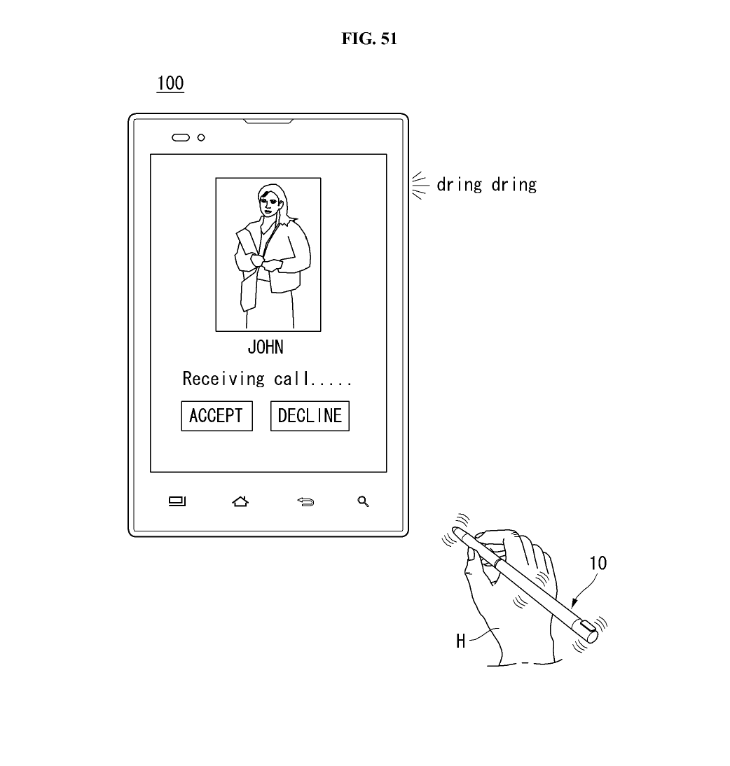

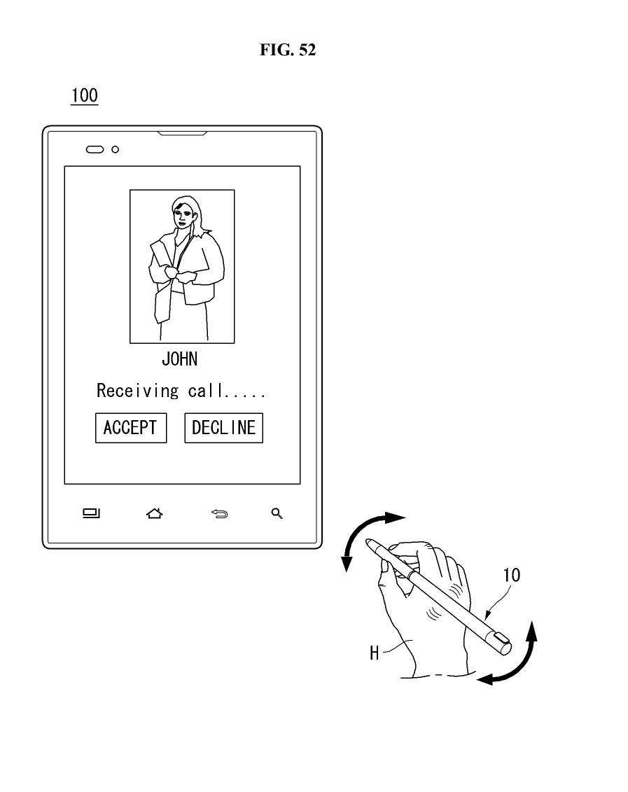

FIGS. 51 and 52 illustrate a stylus function when the mobile terminal of FIG. 1 receives a call.

As shown in FIGS. 51 and 52, upon receiving of a call, the controller 180 of the mobile terminal 100 can control the stylus 10 to perform a specific operation or control the mobile terminal 100 to perform a specific operation in response to a gesture of manipulating the stylus 10.

Referring to FIG. 51, when a call is received, the controller 180 can vibrate the stylus 10. The controller 180 can vibrate the stylus 10 not only when the mobile terminal 100 signals reception of the call using sound or vibration but also when the mobile terminal 100 is in a mute state, and thus the user can be easily aware of the received call even when the mobile terminal 100 is in a bag or pocket.

Referring to FIG. 52, when the user spins the stylus 10, the controller 180 can perform a specific operation for the received call. For example, the controller 180 can control the mobile terminal 100 to enter the mute state, accept the call, or decline the call. If an operation of declining the call is performed using the stylus 10, information on the call may be stored only in the stylus 10. That is, it is possible to store information on a call that the user want to keep in secret only in the stylus 10 and display the information on the mobile terminal 100 in response to a specific user gesture.

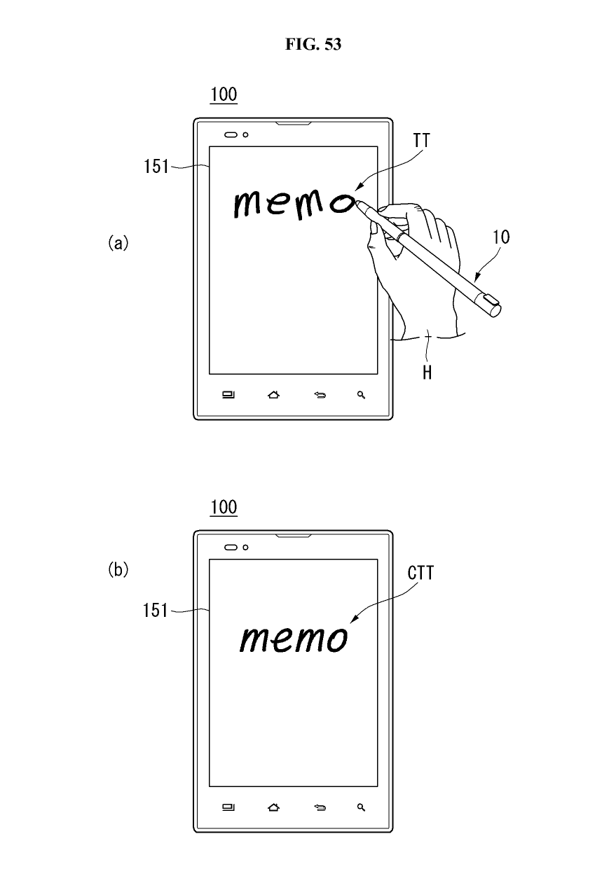

FIG. 53 illustrates a function of correcting a font using the stylus of the mobile terminal of FIG. 1.

As shown in FIG. 53, the controller 180 of the mobile terminal 100 can correct a font written by the stylus 10.

Referring to FIG. 53(a), the user can input letters TT using the stylus 10. The letters TT input using the stylus 10 may be inappropriately written due to grip of the stylus 10 according to the size of the stylus 10.

Referring to FIG. 53(b), the controller 180 can recognize the letters TT input using the stylus 10 and display corrected letters CTT. That is, it is possible to correct the letters TT input using the stylus 10 into fine letters.

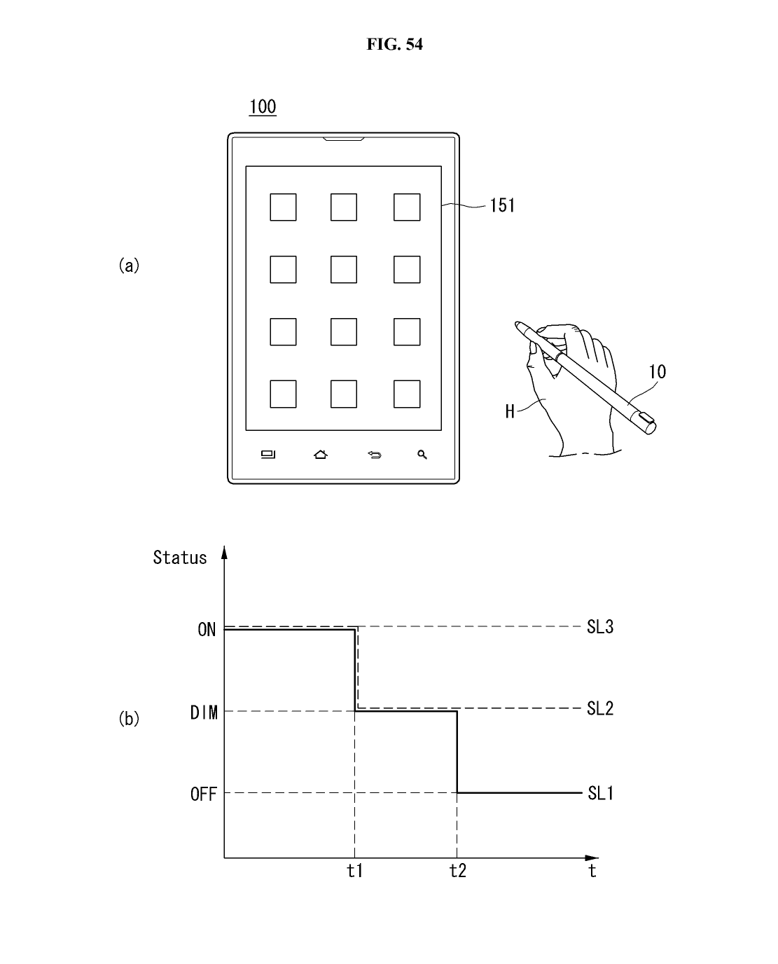

FIGS. 54 to 56 illustrate a function relating to the stylus of the mobile terminal of FIG. 1.

As shown in FIGS. 54 to 56, the mobile terminal 100 may perform different operations according to whether the user grips the stylus 10.

Referring to FIG. 54(a), the user may grip the stylus 10 in a hand H. The mobile terminal 100 can sense gripping of the stylus 10 by the user. For example, the mobile terminal 100 can detect that the stylus 10 is gripped by the user on the basis of a signal acquired through an acceleration sensor included in the sensing unit (41 of FIG. 7) of the stylus 10.

When the gripped state of the stylus 10 is maintained, the controller 180 of the mobile terminal 100 can maintain the display 151 of the mobile terminal 100 in ON state. That is, the controller 180 determines that the user intends to use the mobile terminal 100 because the user grips the stylus 10 and thus maintains the mobile terminal 100 in a state in which the mobile terminal 100 can be immediately used.

Referring to FIG. 54(b), the controller 180 can control the mobile terminal 100 to be in a specific state when the user grips the stylus 10.

The display 151 of the mobile terminal 100 may be in ON state while the mobile terminal 100 is used. That is, the backlight may be turned on when the mobile terminal 100 is activated.

If user input is not applied for a predetermined period of time, the display 151 of the mobile terminal 100 may enter a dim state. For example, the backlight can be turned off at t1 when user input is not applied.

When user input is not applied at t1, the display 151 of the mobile terminal 100 may enter an off state. For example, the display 151 can be turned off at t2 when user input is not applied. This display state variation may be represented along a trajectory indicated by SL1.

The controller 180 can control the display 151 in a manner different from the aforementioned normal manner when the user grips the stylus 10. For example, the state of the display 151 can be changed along trajectories SL2 and/or SL3 when the user grips the stylus 10.

The stylus 10 gripped by the user may represent that the user intends to use the mobile terminal 100. Accordingly, the controller can maintain the display 151 in ON state or wait for user input in a dim state in which only the backlight is turned off.

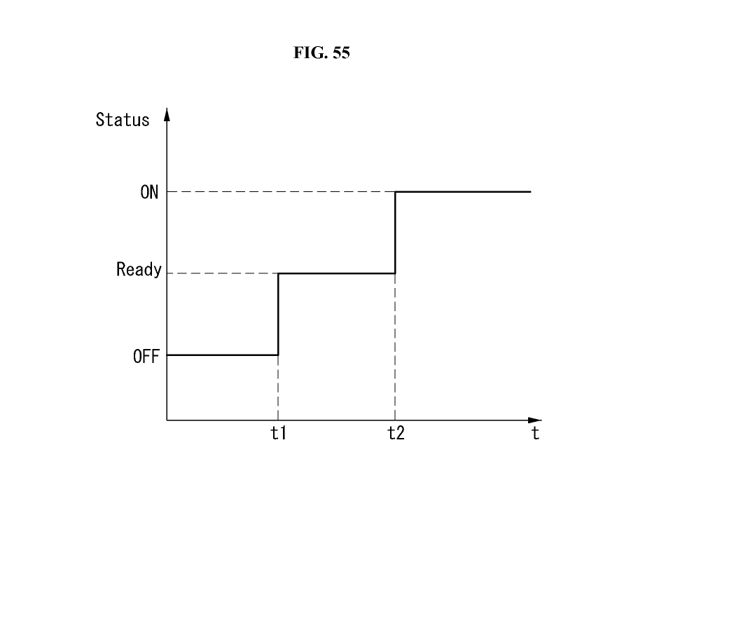

Referring to FIG. 55, the controller 180 of the mobile terminal 100 can change the state of the mobile terminal 100 if the user grips the stylus 10 when the mobile terminal 100 and/or the display 151 are turned off. For example, the controller 180 can change the state of the mobile terminal 10 to a ready state at t1 when the user grips the stylus 10 while the mobile terminal 100 is turned off. For example, the ready state may be a dim state in which the backlight is turned off. Otherwise, the ready state may be a state in which the camera 121 of the mobile terminal 100 is turned on. That is, the camera 121 that photographs the orientation of the eyes of a user who operates the mobile terminal 100 and/or manipulation of the stylus 10 can be turned on in the ready state.

The ready state can be changed to the ON state at t2 when the stylus 10 moves. For example, the backlight is turned on and thus the mobile terminal 100 can be used.

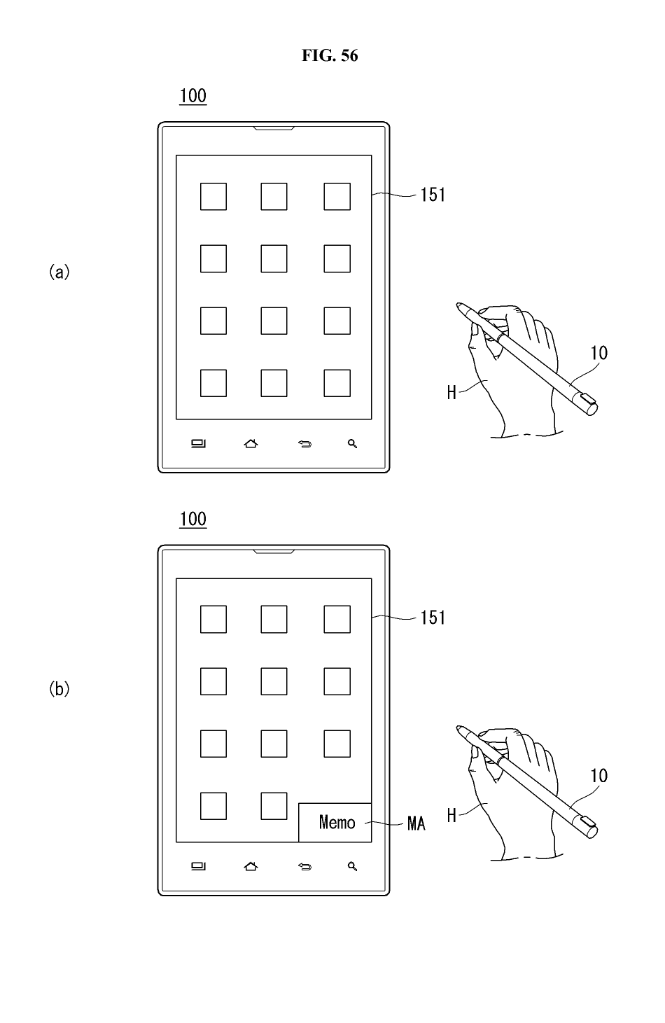

Referring to FIG. 56(a), when the user grips the stylus 10 in the hand H, the display 151 can enter the ON state.

Referring to FIG. 56(b), the controller 180 can execute a specific application at the same time the display 151 enters the ON state. That is, the controller 180 can control an application executed using the stylus 10 to be in a standby state. For example, a memo application MA by which a memo can be written using the stylus 10 can be displayed on the display 151.

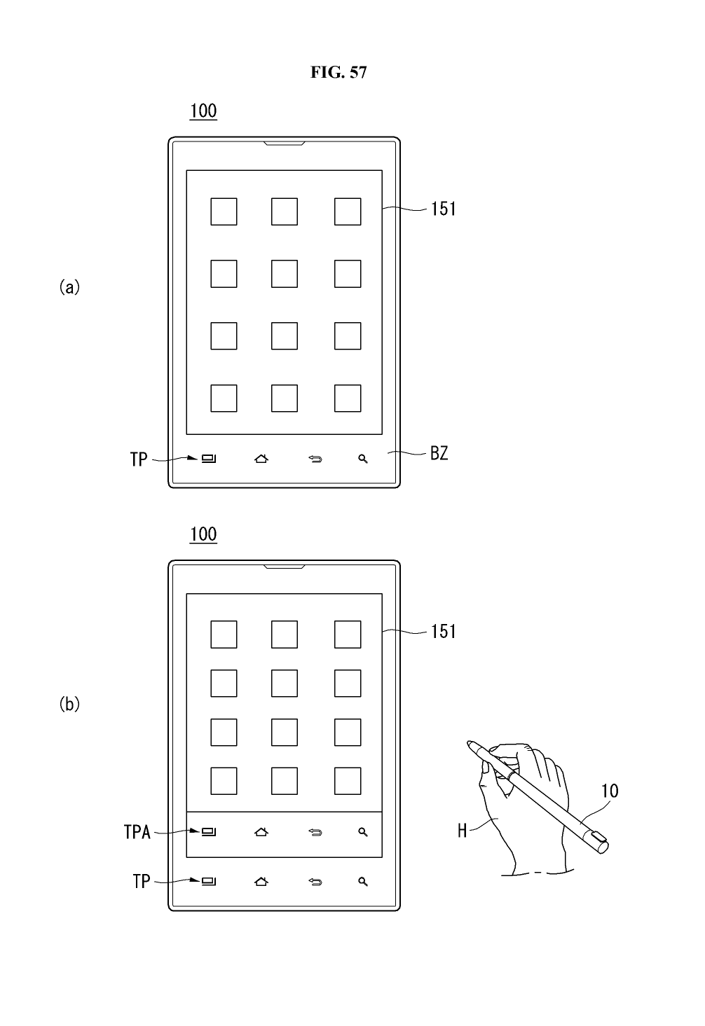

FIGS. 57 to 59 illustrate another function relating to the stylus of the mobile terminal of FIG. 1.

As shown in FIGS. 57 to 59, the controller 180 of the mobile terminal 100 can display buttons of a touchpad TB through which inputs for performing related operations are applied on the display 151 when the user grips the stylus 10.

Referring to FIG. 57(a), the touch pad TP may be provided to a bezel BZ of the mobile terminal 100. That is, a region through which touch input can be received from the user may exist in an area other than the display 151. The touch pad TP may include several independent buttons. Each button can function as a hot key corresponding to a specific function. For example, the touch pad TP can include buttons corresponding to a function of moving to home, a return function, etc.

Referring to FIG. 57(b), when the user grips the stylus 10, a button area TPA corresponding to the buttons of the touch pad TP may be displayed on the display 151. It may be difficult for the user to select the buttons of the touch pad TP using the stylus 10. That is, the touch pad TP may not sense touch using the stylus 10 narrower than a finger of the user since the touchpad TP has touch sensitivity lower than that of the display 151. Accordingly, when the user grips the stylus 10, the controller 180 can enable touch input using the stylus 10 by displaying the button area TPA.

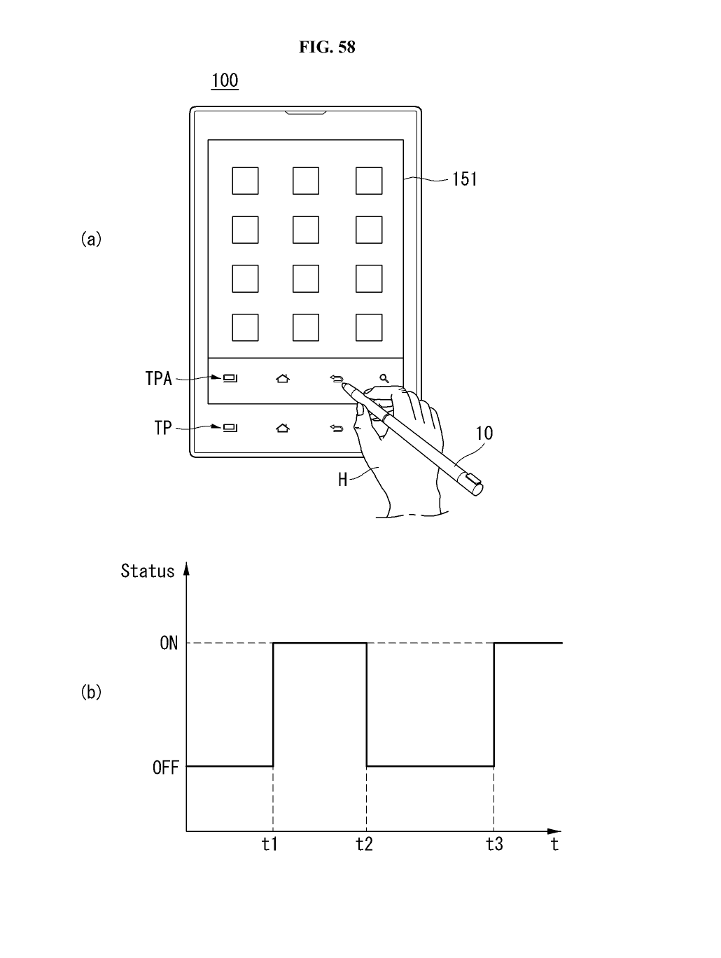

Referring to FIG. 58(a), the user can select a specific button from the button area TPA using the stylus 10.

Referring to FIG. 58(b), the button area TPA can be selectively displayed according to whether the user grips the stylus 10. For example, the button area TPA is displayed during a period from t1 to t2 and after t3 when the user grips the stylus 10, whereas the button area TPA is not displayed during a period from t0 to t1 and a period from t2 to t3 when the user does not grip the stylus 10.

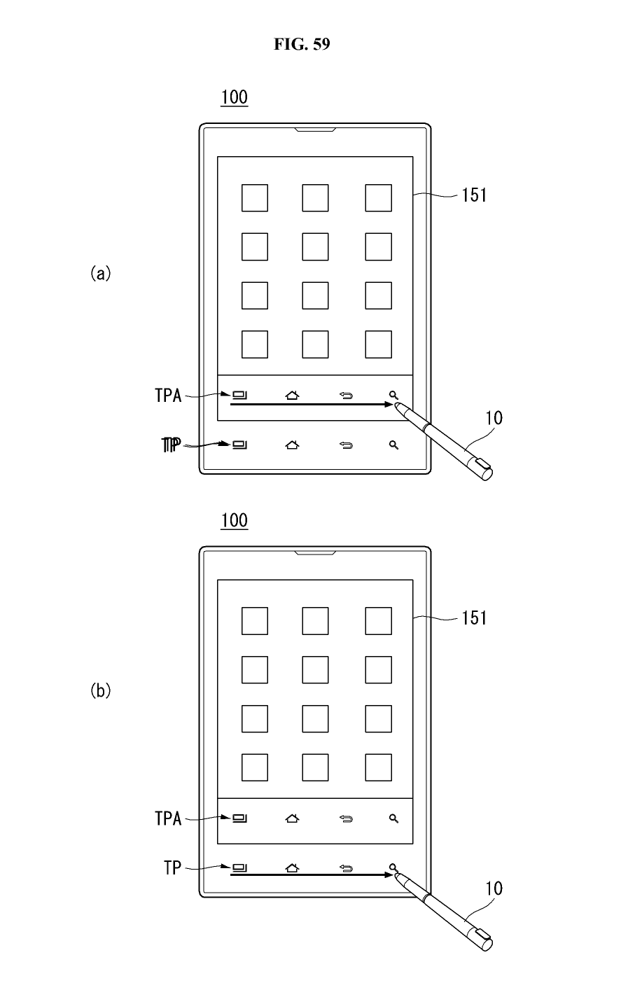

Referring to FIG. 59(a), the user can execute various functions by performing a touch operation such as dragging the button area TPA using the stylus 10. For example, when the user selects a specific button from the button area TPA, a function corresponding to the specific button is executed. If the user drags the button area TPA, functions corresponding to dragged buttons of the button area TPA can be executed on the basis of the number of the dragged buttons.

Referring to FIG. 59(b), the user can drag the touch pad TP using the stylus 10. Though an operation of touching a specific button of the touch pad TP may be not recognized due to weak touch input, an operation of dragging the touch pad TP can be recognized because of strong touch input. When the user drags the touch pad TP, the controller 180 can perform an operation corresponding thereto.

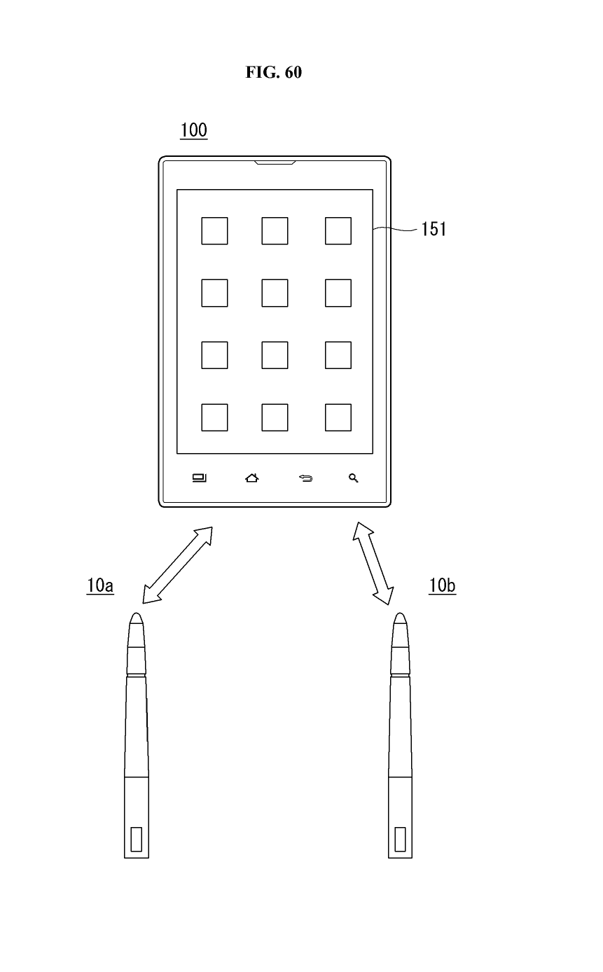

FIGS. 60 to 62 illustrate the relationship between the mobile terminal of FIG. 1 and a specific stylus.

As shown in FIGS. 60 to 62, the controller 180 of the mobile terminal 100 can perform operation depending on the relationship between the mobile terminal 100 and the stylus 10.

Referring to FIG. 60, first and second styluses 10a and 10b may be located around the mobile terminal 100. In this case, the controller 180 can execute a function in response to user touch input applied to a specific stylus previously registered in the mobile terminal 100. For example, if the first stylus 10a is registered and the second stylus 10b is not registered, the controller 180 can manipulate the mobile terminal 100 in response to a user gesture of manipulating the stylus 10a.

Stylus registration may be performed through NFC. For example, when the user moves the specific stylus 10 close to the mobile terminal 100, the stylus 10 can be registered.

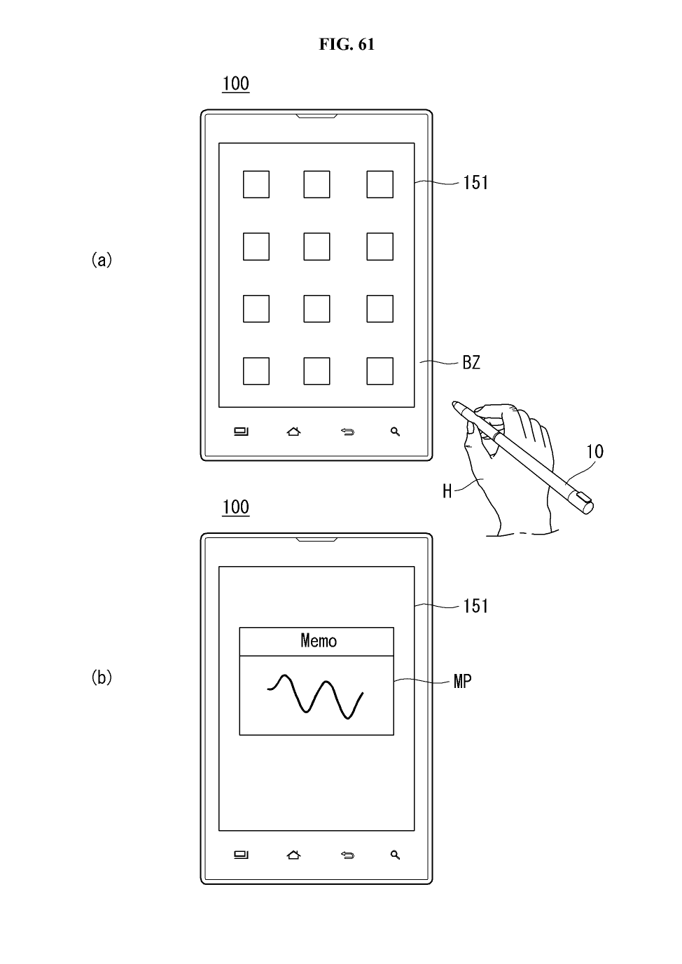

Referring to FIG. 61(a), the user can touch the bezel BZ of the mobile terminal 100 with the stylus 10. For example, the user can touch the bezel BZ with the stylus 10 several times. It is possible to sense whether the stylus 10 touches the bezel BZ several times through a signal acquired through the sensing unit (41 of FIG. 7) of the stylus 10 and/or through the sensing unit (140 of FIG. 1) of the mobile terminal.

Referring to FIG. 61(b), when the user touches the bezel BZ with the stylus 10, the controller 180 can execute an application corresponding to the operation of touching the bezel BZ. For example, the controller 180 can execute a memo application MP when the user touches the bezel BZ with the stylus 10 twice. Different applications can be executed according to the number of operations of touching the bezel BZ.

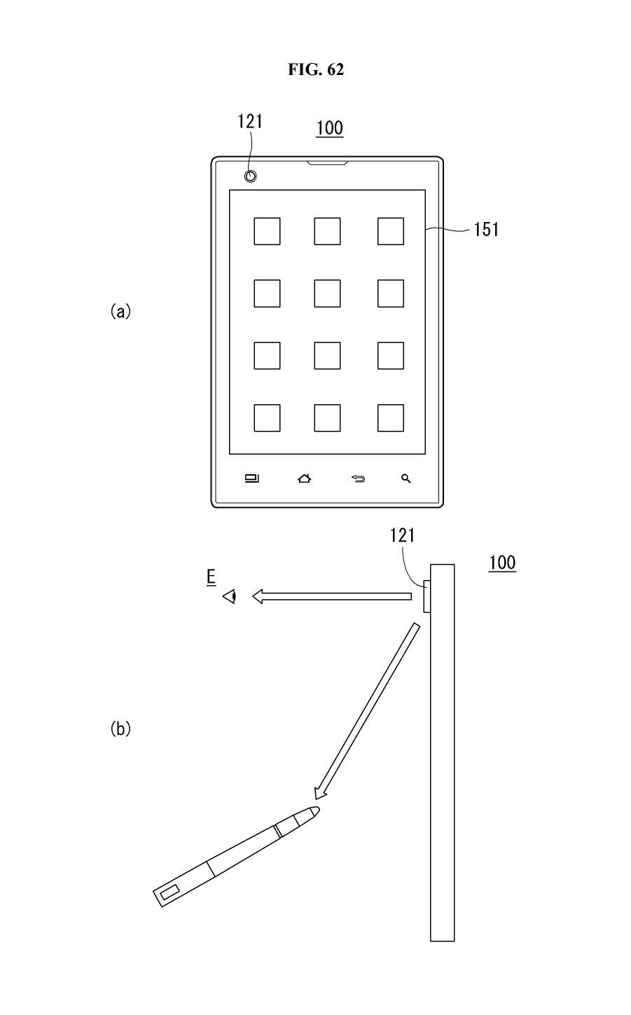

Referring to FIG. 62(a), the mobile terminal 100 may include the camera 121.

Referring to FIG. 62(b), the camera 121 can capture an image of the user of the mobile terminal 100 and/or the stylus 10. For example, it is possible to sense whether the user watches the mobile terminal 100 on the basis of an image of the eyes E of the user, captured by the camera 121. In addition, it is possible to sense whether the user grips the stylus 10 and/or whether the user makes a gesture of manipulating the stylus 10.

Based on captured images of the eyes E of the user and/or the stylus 10, the controller 180 can execute functions corresponding to the captured images. For example, the controller 180 can stop input through the stylus 10 when the user does not watch the mobile terminal 100 or can perform different operations according to the way of the user of gripping the stylus 10.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a display; and
a controller configured to execute a function corresponding to a user gesture acquired through a stylus without contacting between the stylus and the display.

2. The mobile terminal of claim 1, wherein the controller controls the mobile terminal to be in one of an active state, a dim state, a lock state and a standby state, and changes the state of the mobile terminal from the active state to the standby state or from the standby state to the active state, without passing through the dim state and the lock state using the stylus.

3. The mobile terminal of claim 2, wherein the controller controls the mobile terminal to enter the dim state, when the controller acquires a user gesture of putting down the stylus on an area other than the display.

4. The mobile terminal of claim 3, wherein the controller controls the mobile terminal to enter the active state when the controller acquires a user gesture of gripping the stylus in the dim state.

5. The mobile terminal of claim 1, wherein the controller controls the mobile terminal to enter the standby state when the controller acquires a user gesture of putting down the stylus on the display.

6. The mobile terminal of claim 5, wherein the controller controls the mobile terminal to enter the active state when the controller acquires a user gesture of gripping the stylus in the standby state.

7. The mobile terminal of claim 5, wherein the controller displays a window for unlocking a lock screen in a position corresponding to a direction in which tip of the stylus points when the controller acquires a user gesture of gripping the stylus in the standby state.

8. The mobile terminal of claim 7, wherein, when the direction of the tip of the stylus is changed, the controller changes the position of the window for unlocking the lock screen such that the window for unlocking the lock screen corresponds to the changed direction of the tip of the stylus.

9. The mobile terminal of claim 5, wherein the controller displays at least one shortcut icon on a lock screen such that the mobile terminal enters the active state through the at least one shortcut icon without an operation of unlocking the lock screen, when the controller acquires a user gesture of gripping the stylus in the standby state.

10. The mobile terminal of claim 1, wherein the controller executes a function depending on a distance between the stylus and the display.

11. The mobile terminal of claim 10, wherein the controller changes at least one of thickness, brightness and display duration of a trajectory displayed in response to a user gesture of manipulating the stylus according to the distance between the stylus and the display.

12. The mobile terminal of claim 1, wherein, when a user gesture of spinning the stylus is obtained, the controller changes at least part of an image displayed on the display on the basis of at least one of a spinning direction and a number of spinning.

13. The mobile terminal of claim 1, wherein the controller changes location of an image displayed on the display such that the stylus is not positioned on the image.

14. The mobile terminal of claim 1, wherein, when a use gesture of shaking the stylus is acquired, the controller displays an icon corresponding to at least one of a function executable using the stylus and a function recently executed using the stylus on a region pointed by the stylus at a specific time of shaking the stylus.

15. The mobile terminal of claim 1, wherein the use gesture includes at least one of a gesture of gripping the stylus such that a tip of the stylus points the display, a gesture of gripping the stylus such that an end of the stylus, opposite to the tip, points the display, a gesture of spinning the stylus in one direction or opposite direction, a gesture of shaking the stylus, a gesture of rubbing the stylus, and a gesture of pushing a button of the stylus.

16. A mobile terminal comprising:
a display; and
a controller configured to change the mobile terminal from at least one of an active state, a dim state, a lock state and a standby state to another state on the basis of at least one of relative positions of a stylus and the display and a user gesture of manipulating the stylus.

17. The mobile terminal of claim 16, wherein the controller changes the state of the mobile terminal from the active state to the standby state, or from the standby state to the active state, without passing through the dim state and the lock state using the stylus

18. A method of controlling a mobile terminal, comprising:
acquiring a user gesture of manipulating a stylus;
obtaining information about whether the stylus contacts with a display; and
executing a function corresponding to the user gesture when the stylus does not contact with the display.

19. The method of claim 18, wherein the executing of the function comprises controlling the mobile terminal to be in one of an active state, a dim state, a lock state and a standby state, and changing the state of the mobile terminal from the active state to the standby state, or from the standby state to the active state, without passing through the dim state and the lock state using the stylus.

20. The method of claim 18, wherein the executing of the function comprises executing a function depending on a distance between the stylus and the display.
